(19) United States
(12) Patent Application Publication
(10) Pub. No.: US 2004/0126892 A1
(43) Pub. Date: Jul. 1, 2004

(54) Methods for characterizing a mixture of chemical compounds

(76) Inventors: Andrey Yurievich Bogomolov, Moscow (RU); Michael McBrien, Milton (CA)

Correspondence Address: TESTA, HURWITZ & THIBEAULT, LLP, HIGH STREET TOWER, 125 HIGH STREET, BOSTON, MA, 02110, US

(21) Appl. No.: 10/668,111

(22) Filed: Sep. 19, 2003

Related U.S. Application Data
(60) Provisional application No. 60/412,655, filed on Sep. 20, 2002.
(60) Provisional application No. 60/420,055, filed on Oct. 21, 2002.

(51) Int. Cl. G06F 19/00; G01N 31/00; G01N 30/02

(52) U.S. Cl. 436/161; 702/22

(57) ABSTRACT

In general, the invention relates to techniques for distinguishing and resolving all or some subset of the chemical compounds in a mixed sample. The individual chemical components may all be known, unknown or combinations thereof. In particular, the invention relates to “n-Dimensional MAP Chromatography” (NDMC) as a technique for performing chromatographic analysis on a sample containing multiple components. Other aspects of the invention relate to techniques for peak and component matching across different experiments that complement and form part of NDMC in one specific embodiment.

### CROSS-REFERENCE TO RELATED APPLICATIONS

This application claims the benefits of and priority to provisional U.S. Provisional Patent Application Serial No. 60/412,655 filed on Sep. 20, 2002; and to provisional U.S. Provisional Patent Application Serial No. 60/420,055 filed on Oct. 21, 2002 the disclosures of which are hereby incorporated herein by reference in their entirety.

### FIELD OF THE INVENTION

The present invention relates generally to the field of chromatography. In particular, the invention relates to techniques for characterizing and extracting information from portions of chromatographic data.

### BACKGROUND OF THE INVENTION

The demand for obtaining contents information about samples in the medical, pharmaceutical, biological research, and industrial communities continues to fuel the need for accurate and fast chemical research tools and techniques. In particular, new methods and improved techniques for characterizing chemical behavior and identifying chemical components within complex mixtures represent areas of significant interest in these various fields and disciplines. Much of the ongoing work lies in the field of chromatography. As the methodologies and understanding of chromatographic approaches continue to develop, better analytical and purification tools become available.

Yet, there are a number of factors that impact the utility of various chromatography techniques. Obtaining chromatographic data is generally a time-intensive pursuit. A great deal of instrument and operator time is expended on attempts to resolve and quantify the chemical components of interest and the impurities in a given sample. Resolving a given set of components for a particular sample, such that quantification and extraction of spectra and chromatographic data is possible, can take weeks.

Additionally, even with the expenditure of large amounts of operator time, it may be impossible to resolve all of the components within a sample, given the constraints of the chromatographic system being employed and the guess work associated with many modern day techniques. For example, in instances when chemical components elute at the same time (exact co-elution) or closely one by one so that their mixture passes the detector (partial co-elution), overlapping peaks will result. The presence of overlapping components can complicate or possibly even negate the chromatographer's ability to detect and quantify the components in a particular sample. Thus, obtaining meaningful information from the time intensive experiments can be futile in some circumstances.

A partial solution to this problem is to combine sequentially separation conditions that exploit two different physicochemical parameters of given components such that component fractions are collected periodically during the first run of the first chromatographic system and then injected into a second chromatographic system in order to resolve any components that co-eluted in this fraction. The second chromatographic system is generally designed to separate based on a mechanism that is as different as possible from the first system. This “two dimensional” chromatography is most commonly applied to extremely complex protein and volatile samples. 2D chromatography allows for resolution of far more complex samples than normal chromatography, and concurrently reduces the onus on chromatographic method development. However, it has the serious drawback of requiring complex instrumentation. This complexity certainly precludes the routine scaling of the technique to further dimensions such as 3-dimensional or 4-dimensional chromatography.

Therefore a need exists to provide methods and techniques for resolving chemical components that improves over existing time-intensive operator-based methods, while addressing the problems associated with co-eluting components and the associate overlapping peak data that results.

### SUMMARY OF THE INVENTION

The term peak generally refers to a concentration profile of an individual analyte while it passes through a chromatographic detector, as a result, the detector produce a signal that is recordable. Modern spectral detectors record multiple signals at the same time (e.g., absorbance at many wavelengths) and thus can produce a matrix of data instead of a classical chromatographic curve with peaks. As used herein, the term spectrochromatogram refers to a matrix of data representing an individual chromatographic separation (run). In certain embodiments, absorbance values contribute the physical data comprising a spectrochromatogram. Throughout the disclosure, reference is made to “peak matching” and “chemical component matching,” the concept of peak matching and component matching may be substantially the same, except in instances where one peak corresponds to more than one component. This may occur when two components co-elute and are detected as overlapping peaks. The terms “component” and “compound” generally are used interchangeably as an individual chemical compound in a mixture. Component has the additional connotation of suggesting a particular compound that is part of a mixture. Similarly, the use of the term compound emphasizes its nature as an individual chemical substance. Peak co-elution occurs when the peak maxima of two or more components coincide exactly. Partial co-elution means overlapped peaks of two (or more) components eluting at close but different retention times. While overlapping component peaks may result in a signal comprising a sum of the underlying peaks having a single maximum value or multiple relative maximum values.

The present invention relates to methods for characterizing a mixture of chemical components. In one embodiment, this characterization of the mixture is qualitative and quantitative. Generally, characterizing a sample of component compounds refers to distinguishing among, finding the number of, identifying, comparing, mathematically and/or chromatographically resolving, modeling resolution behavior of, finding quantitative parameters such as concentrations of, and otherwise obtaining information about the components present in the sample. Resolving a component in the sample may be achieved through chromatographic experimentation wherein the component elutes independently of other compounds or through the methods of the invention which may resolve components that are associated with overlapping peaks in various chromatographic experiments in one embodiment.

The invention has two main applications according to one embodiment. The first is the detection and tracking of mixture components as a function of method variables for subsequent chromatographic method development, in manual, computer-assisted, and automated form. The second application is to the extraction of mixture information in its own right. Computer assisted method development (CAMD) is a technique where chromatographic conditions are varied and peak movements are monitored. CAMD represents one aspect of the invention in various embodiment CAMD may use the various component characterization methods outlined in more detail below. Typically the peak movements are individually modeled such that the best chromatographic conditions can be designed in order to optimize the quality of the separation. One aspect of this approach is the tracking of chromatographic peaks between runs. Given two (or more) spectrochromatograms of the same mixture obtained under differing experimental conditions, one aspect of the invention is capable of selecting a pair of (or more) peaks, such that those peaks are related to the same component in different experimental runs. For pure peaks, spectra recorded in peak maxima can be compared directly. This is easily accomplished as the same spectral shape may evidence the same component. However, when components co-elute the spectra represent a mixed response of two or more components and spectral shape cannot be relied upon as a basis for identification. Thus, in one aspect of the invention, peaks present in different chromatographic runs are matched in order to characterize the components of a given sample, even if co-elution is present. This facilitates another aspect of the invention relating to analyzing a sample containing multiple components by estimating the number of components, performing multiple chromatographic experiments under differing conditions, and using any suitable peak matching technique to interrelate the data between the different experiments.

Additionally, although the detailed description may refer to peaks, graphs, spectrochromatograms, and other types of related data, it is understood that the usage refers to the underlying data and/or the graphical representation of the data as is appropriate or discernable to one of ordinary skill in the art in a particular context. Similarly, the term component refers to each of the unique chemical compounds comprising a given sample of interest.

In one aspect the invention relates to a method of component peak matching. In some embodiments this method is referred to as Mutual Automated Peak Matching (MAP). A modified iterative key set factor analysis approach is used in some MAP embodiments to determine a set of orthogonal spectra. Orthogonal Projection Approach (OPA) and a pure variable selection method as a part of Simple-to-use Interactive Self-modeling Mixture Analysis (SIMPLISMA) can be used for selecting orthogonal spectra in various embodiments. This list of techniques for determining a set of orthogonal spectra is not meant to be exhaustive, as various techniques known to those skilled in the art or as of yet not contemplated can be used to accomplish spectra selection. For more details on SIMLISMA see U.S. Pat. No. 5,481,476, the disclosures of which are herein incorporated by reference. The techniques and core processes disclosed herein can be extended to all areas of chemical research employing chromatography-based methods.

In one embodiment, a data processing device implements the functionality of the methods of the present invention as software on a general purpose computer. Such a program may set aside portions of a computer's random access memory to provide control logic that affects the various operations associated with aspects of the invention, including data preprocessing and the operations with and on the spectrochromatogram data as well as other data types relevant to the methods of the invention. In such an embodiment, the program is written in any one of a number of high-level languages, such as FORTRAN, PASCAL, DELPHI, C, C++, or BASIC. Further, the program in various embodiments is written in a script, macro, or functionality embedded in commercially available software, such as MATLAB or VISUAL BASIC. Additionally, the software in one embodiment is implemented in an assembly language directed to a microprocessor resident on a computer. The software may be embedded on an article of manufacture including, but not limited to, “computer-readable program means” such as a floppy disk, a hard disk, an optical disk, a magnetic tape, a PROM, an EPROM, or CD-ROM.

In another aspect the invention relates to a method for mutual peak matching in a series of chromatographic analyses of the same mixture under varying conditions. The method does not require any prior knowledge of the mixture composition. The method is tolerant to overestimation of the number of components produced by initial principal component analysis (PCA). Further, the calculated retention times achieved using aspects of the invention provide a good initial estimate for subsequent curve resolution if the latter is necessary.

In one aspect the invention relates to methods for tracking the movement of peaks as separation conditions are changed. Some aspects of the invention relating to MAP do not require any prior knowledge of the mixture composition. Applying PCA and IKSFA on an augmented data matrix, the method detects the number of mixture components and calculates the retention times of substantially every individual compound in each of the input chromatograms. All or a subset of the candidate components of the spectrochromatogram are then validated by target testing for presence in each chromatographic run to provide quantitative criteria for the detection of “missing” peaks as well as confirming successful matches.

The matching method may serve for obtaining a good initial estimate for further modeling and curve resolution. Over the last two decades, a wealth of excellent work has been devoted to the curve resolution problem using multivariate data analysis methods. Comprehensive overviews of these methods are made in Malinowski's book (See E. R. Malinowski, Factor Analysis in Chemistry, third ed., Wiley/Interscience, New York, 2002. The disclosure of which is herein incorporated by reference) and in the paper by Hamilton and Gemperline (See J. C. Hamilton, P. J. Gemperline, J. Chemom. 4 (1990) 1. The disclosure of which is herein incorporated by reference).

A new method of peak matching in a series of spectrochromatograms of the same mixture obtained under varying separation conditions is an aspect of the invention. This method solves two interrelated problems simultaneously: the definition of the main number of analytes in the mixture and the evaluation of their retention times in each experiment of a series. The method performs well under poor separation conditions while peak intensities vary dramatically. Methods for reducing noise and screening out non-analyte factors are also features of one embodiment. Another important feature of the method is its applicability to inconsistent data. Missing components in one or several experiments can be detected in various embodiments of the invention.

An article “Mutual Peak Matching in a Series of HPLC-DAD Mixture Analyses” by Bogomolov and McBrien Analytica Chemica 490 (2003) 41-58 is herein incorporated by reference in its entirety.

### BRIEF DESCRIPTION OF THE DRAWINGS

The invention is pointed out with particularity in the appended claims. The advantages of the invention described above, together with further advantages, may be better understood by referring to the following description taken in conjunction with the accompanying drawings. In the drawings, like reference characters generally refer to the same parts throughout the different views. The drawings are not necessarily to scale, emphasis instead generally being placed upon illustrating the principles of the invention.

FIG. 1 is a block diagram illustrating a component characterizing method according to an embodiment of the invention;

FIG. 2 is an illustrative schematic diagram of chromatographic device suitable for use with various embodiments of the invention;

FIG. 3 is graph illustrating the results of two chromatography experiments obtained for the same sample under differing conditions according to an embodiment of the invention;

FIG. 4A is a series of graphs illustrating three chromatographic experiments on a sample comprising three components and an application of the peak component matching methods of an embodiment of the invention;

FIG. 4B is a table of data describing some of the results and values relevant to FIG. 4A;

FIG. 5A is a graphical representation of one type of spectrochromatogram according to one embodiment of the invention;

FIG. 5B is a plot of various chromatographic experiments suitable for use with one embodiments of the invention;

FIG. 6 is a schematic representation of the formation of an augmented data set according to one embodiment of the invention;

FIG. 7A is a schematic diagram illustrating an embodiment of the MAP method according to one embodiment of the invention;

FIG. 7B is a schematic diagram illustrating an embodiment of the MAP method according to one embodiment of the invention;

FIG. 8 the relationship of various matrix elements are illustrated according to one embodiment invention;

FIGS. 9A and 9B illustrate plots and component concentration profiles in series A data and series B data according to one embodiment of the invention.

FIGS. 9C illustrate spectra of components in series A data according to one embodiment of the invention;

FIGS. 9D and 9E illustrate underlying spectra used to generate series B data according to one embodiment of the invention;

FIG. 9F illustrates key set spectra 10 and 11 in series A. data according to one embodiment of the invention;

FIGS. 9G and 9H illustrate target test results for component 3 in series A data according to one embodiment of the invention;

FIG. 9I illustrates refined key set spectra in series B data according to one embodiment of the invention; and

FIG. 9J illustrates ALS MCR curve resolution in experiment 2 (series B data) according to one embodiment of the invention

### DESCRIPTION OF THE PREFERRED EMBODIMENTS

Embodiments of the present invention are described below. It is, however, expressly noted that the present invention is not limited to these embodiments, but rather the intention is that modifications that are apparent to the person skilled in the art and equivalents thereof are also included.

In general, the invention relates to techniques for resolving all or some subset of the chemical compounds in a mixed sample. The individual chemical components may all be known, unknown or combinations thereof. In particular, the invention relates to “n-Dimensional MAP Chromatography” (NDMC) as a technique for performing chromatographic analysis on a sample containing multiple components. Other aspects of the invention relate to techniques for peak and component matching across different experiments that complement and form part of NDMC in one specific embodiment. As described in the background of the invention, traditional two-dimensional chromatography has the serious drawback of requiring complex instrumentation. Further, by physically linking together different chromatography methods with one or more detectors, conventional 2D chromatography limits experimental flexibility with respect to certain conditions such as changing the solvent between runs or varying the gradient conditions.

In NDMC approaches, multiple chromatographic experiments are run under different conditions. Under these different conditions individual components undergo some degree of separation and elution at different times. The extent that peaks co-elute in a single spectrochromatogram is not a limitation on being able to extract meaningful data about component retention times in each spectrochromatogram of the series, as long as there is some degree of change in separation conditions in each run NDMC is applicable. This is true even if two or more components partially co-elute with each other through all the series. The individual experiments need not be complex and in some embodiments the only change between experimental runs may be the use of a different column. All of the chromatographic data collected during the experimental stage are arranged in a suitable form for further processing. This typically takes the form of an augmented data matrix, which is discussed in more detail below. Once all of the experiments are completed the number of components is estimated either through known information such as the expertise of the experiment or through a series of applied methods such as a principal component analysis approach. The next stage of NDMC is to apply a matching process on the data obtained to extract information about each of the components in the sample.

As part of this general component matching phase of the NDMC process, spectral information is used to match or track components within different chromatographic datasets obtained at different times. This matching/tracking technique may be used even when the components co-elute with other components in the sample. Mutual Automated Peak Matching (MAP) refers to one of the various embodiments of the invention used to track or match the chemical compounds in a given sample as that sample is analyzed in different chromatographic experiments. MAP represents one approach to performing the component/peak matching required by NDMC. The details of various peakmatching methods are discussed in greater detail below.

Generally, in various embodiments MAP is a method of multivariate statistical analysis of chromatographic data. The MAP technique makes use of an augmented data set as introduced above and discussed in more detail below. In the event an estimate of the number of components is not known, a process such as PCA can be performed on the augmented data.

The next step of the MAP technique involves selecting a set of the (n) most orthogonal spectra, this is referred to as a key set. A non-normalized modified IKSFA approach can be used to perform this selection in one embodiment. These orthogonal spectra represent a subset of real spectral data that are the columns of the augmented data set. The key set spectra represent axes of a new factor space suitable for modeling the raw data. Redundant spectra in the key set or those bringing no information but experimental noise may negatively impact method performance. Therefore, generating an optimal key set that spans the space of augmented data, while making effective use of a smaller number of suitable factors is desirable. Thus various steps of the MAP techniques can be used to improve the selected key set candidates by eliminating those spectra that do not serve to enhance method performance. Having obtained an optimal key set it can be used to model the augmented data set and extracting information about the retention times for each component within each spectrochromatogram. These details and other steps of the MAP technique are discussed in more detail below.

Various aspects of the invention are suitable for use with a range of spectrochromatographic and analytic methods. As used herein, a spectrochromatographic method refers to coupling a chromatography technique with a spectral method. The spectrochromatographic methods used in various aspects of the invention can employ any suitable combination of spectral methods and chromatography techniques.

For example, the application of the invention's techniques is suitable for use with the following non-exhaustive list of chromatography types: HPLC (High Performance Liquid Chromatography), GC (Gas Chromatography), CE (Capillary Electrophoresis), Supercritical Fluid Chromatography (SFC), high throughput solid phase extraction, and flash chromatography. Additionally, various spectral techniques either alone or in combination with each other are also suitable for use in combination with a particular type of chromatography. A non-exhaustive list of suitable spectral methods includes: mass spectroscopy (MS), Fourier transform infrared spectroscopy (FTIR), near infrared spectroscopy (NIR), UV/Vis absorption spectroscopy, such as for example with diode-array detection (DAD) or other detection devices, atomic emission spectroscopy (AES) and other suitable spectroscopies either known now or to be developed in the future. In some embodiments, a given chromatography method is coupled with one or more spectral methods to help ensure that compounds that may be “invisible” to one spectral method are detected by the other complementary spectral method.

Thus, according to the teachings of the invention by increasing the number of experiments performed and/or selecting complementary experimental parameters for each of the subsequent chromatographic experiments, samples of theoretically unlimited complexity can be resolved through suitable peak/component matching techniques. The term “n-Dimensional MAP Chromatography” can be used to describe the aspects of the invention directed to component resolution methods and techniques. The invention achieves this, in part, by using multiple chromatographic runs on the same sample in order to affect resolution of the constituent components in a sample in a manner comparable to 2D chromatography, without the need for complex instrumentation and extensive chromatographic method development. These aspects of the invention may be embodied in software or a specific program as well as any other suitable manner to accomplish the steps of the various methods.

The ability of NDMC to characterize a given sample depends on the complexity of the sample versus the number of methods applied, but the probability of success is highly dependent on the resolution between a given pair of components in at least one of the runs. To clarify, a given component does not necessarily have to be chromatographically resolved from all other species in any single run, but it must not co-elute exactly with the same component(s) in every run. If two or more components exactly co-elute with each other in every run, they will be seen as the same component, with a single spectrum that is the combination of the two contributors. To ensure that resolution is attained, it is important to employ methods that are as different as possible. At the same time the peak matching method assumes that the species has a constant spectrum through all runs. For this reason, it is important to choose the different chromatographic conditions carefully. Ideally, the methods will give very different elution results for each species, but will not change the spectra of the species too much from run to run, easing the recognition burden of the MAP method. The selection of the chromatographic methods for this purpose is thus a significant part of the NDMC process.

The peak/component matching tools used in the NDMC process depends on the spectral differences of given components in the sample. UV-Vis spectra are not ideal as “fingerprint” spectra even for components that have chromophores. However, the ubiquitous nature of UV-Vis detectors has led to the utilization of these spectra for fingerprint-type operations such as peak purity measurement; a technique that has been applied with reasonable success. Unlike peak purity applications, MAP does not depend on a single run to detect co-elution of components. Peak purity algorithms based on vector analysis (for example, see Gorenstein et. al., LC-GC 12, no.10, 1994, pp.768-772, the disclosures of which are herein incorporated by reference in their entirety) examine each peak for homogeneity across the entire elution profile. In cases where the elution characteristics of two components are essentially identical (co-elution), peak purity algorithms will not distinguish the components. On the other hand, MAP can distinguish the components provided that their relative elution times vary in a subsequent run. Hence, the application of multiple orthogonal chromatographic methods affords the system a much greater opportunity for detection of all of the components, even in very complex samples. For relatively simple samples it is possible to resolve systems with good confidence using only UV-Vis detection.

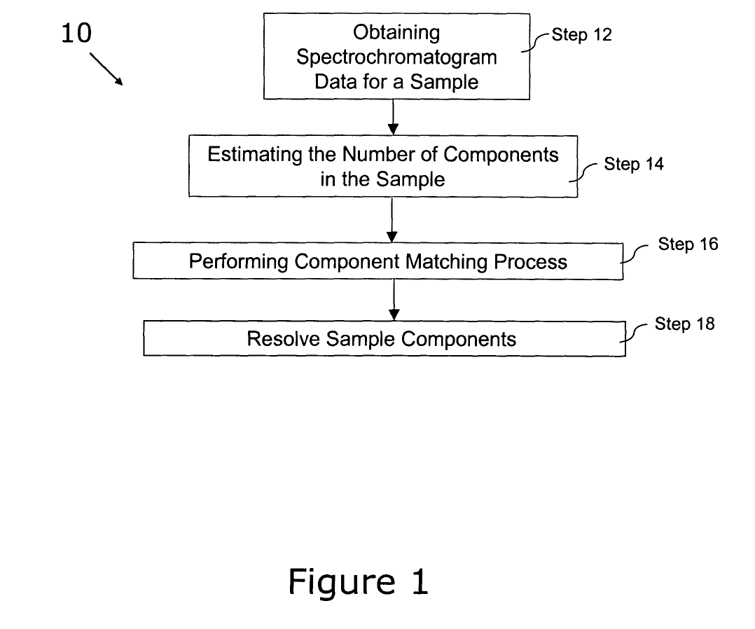

FIG. 1 illustrates the steps for a method embodiment of the invention 10 for characterizing a sample containing a mixture of unique chemical components. Initially, a sample comprising two or more mixed chemical compounds is obtained. For example, this sample may be the result of a complex chemical synthesis for biological or pharmacological research application. However, any sample of chemical components can be characterized using the methods described herein independent of the origin or nature of the sample.

The sample is subjected to two or more chromatographic experiments thereby obtaining spectrochromatogram data for the sample (Step 12). These two or more chromatographic runs are chosen such that different conditions and/or parameters are used in each run.

In some embodiments, the columns of a spectrochromatogram are assigned the values of the time axis. Alternatively, the term spectrochromatogram can also refer to any graphical representation of the underlying data obtained through a given chromatography experiment coupled with a spectral method. The retention time for a compound in a particular sample is the time corresponding to the maximum concentration of the eluting compound while it passes a detector.

In some embodiments, within a given spectrochromatogram the columns of the matrix are formed by spectra (e.g., UV-Vis spectra) instantly recorded by a detector during the chromatographic separation. That is, the columns of the spectrochromatogram comprise spectral data in the form of a column vector, with different column corresponding to a different detection point in time. The time values corresponding to spectra form the time axis. In other embodiments, wavelengths corresponding to matrix rows form the spectral axis of the data.

In the case of diode array detector and various other detector based methods, the spectral axis corresponds to the different wavelengths used by a detector. In various embodiments, a diode array detector is used to receive information about a sample of interest and its constituent components. In such embodiments, each diode records the spectral absorbance at a certain wavelength. These wavelengths form the spectral axis of the data.

In one embodiment of the MAP technique, the solution for the component retention times is initially obtained as indices of the matrix columns. The solution is transformed into the physical data by relating the indices to the appropriate corresponding values on the assigned axis of retention time.

In a given chromatographic run where spectral and retention time data is obtained, there will be “peaks” in the data that correspond to individual components or multiple components where co-elution occurs. In some instances the terms peaks and components are used interchangeably, however the possibility of co-elution is understood, thus some peaks might be associated with multiple components. Further, the invention is directed to manipulating the underlying data associated with a given hyphenated approach to studying a particular sample, thus although “peaks,” “spectrochromatograms,” and “chromatograms” can be plotted as graphical representation, these terms are meant to include the underlying data that the methods of the invention can access and manipulate.

Once the sample has been analyzed to generate multiple spectrochromatograms, estimating the number of components in the sample (Step 14) can be performed. If the number of components is known a priori for the sample being studied, this step may be omitted. In other embodiments of the invention, estimating the number of components is achieved as part of the component matching technique. Given a plurality of spectrochromatograms it is now possible to perform a component/peak matching process (Step 16). These processes are discussed in more detail below. By operating upon the data contained within an augmented data set comprising all spectrochromatograms, it is possible to match up peaks between runs (Step 16), while accounting for exact or partial co-elution of components. Once all of the peaks are matched, at this point any problematic co-eluting components have been identified as part of the MAP or other suitable peak matching method. This allows for the sample component spectra and respective concentration profiles to be resolved (Step 18). The steps of the method 10 may be repeated with new chromatographic runs added. This facilitates identifying co-eluting compounds in the event that the initial estimate of the total number of compound is incorrect or if the number of runs is insufficient to distinguish all of the runs given overlapping peaks, errors or other factors.

This technique facilitates resolving complex samples with a minimum of custom chromatographic work. A series of standard chromatographic runs are performed using different orthogonal chromatographic conditions designed to ensure different results for different components. By using the MAP matching technique, the number of components is determined, each component is resolved for an individual retention time. Based on this result, the NDMC method allows chromatographers to determine component spectra, concentration profiles and possibly concentration (applying additional calibration data), that may never be resolved in a single chromatographic run.

Some of the conditions that can be varied in a specific chromatographic run include, but are not limited to: column type, column length, L; column diameter, D; column temperature; column particle size; the dead time of the system; and combinations thereof. Additional chromatographic methods parameters that can be varied to affect varying peak separations between each of the spectrochromatograms obtained for a given sampled include the pH of the buffer; solvent data (such as mobile phase, buffers, and gradient program for example); flow rate; and combinations thereof.

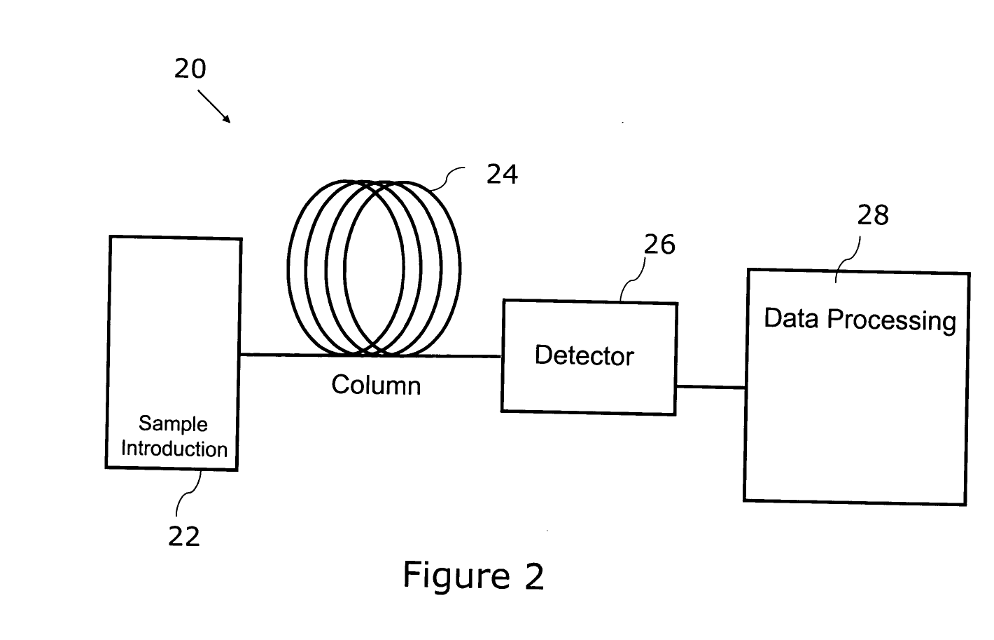

FIG. 2 shows a high level schematic of a generic chromatography experimental apparatus 20 suitable for use with various aspects of the invention. The setup 20 shown includes a sample delivery device 22 (for example, an injector) for receiving the sample of mixed component compounds and introducing the sample into a chromatography column 24. A detector 26 is in communication with the column 24 for receiving the portions of the sample as its components elute over time and for measuring aspects of the received eluant.

One of the most effective methods for changing chromatographic responses of components is changing the column 24 used for the separation. Changing the column 24 between experimental runs serves to introduce variation in the separation conditions and thus enhance the differences between various spectrochromatograms for use in component resolution. However, typically changing the column introduces minimal changes that will be detected by the spectral method being employed and any background noise introduced by a different column will be minor. Recently, there have been a number of developments in chromatographic column science, both in column characterization and in material design. This affords an opportunity to select orthogonal columns for use in concert with a chromatographic method as part of the larger experimental setup 20. The column 24 can be varied while the rest of the separation conditions remain fixed. This also has the advantage of easing the requirements of reagent inventory and preparation.

For more complex samples, it may be convenient to vary other parameters. One choice is the speed of the solvent gradient. By using a slow and a fast gradient, it is possible to achieve significant resolution of both early and late eluting components respectively. In fact, practically any parameter can be varied, including temperature, pH, solvent modifiers, buffer concentrations, etc. Of these, pH has arguably the most power (particularly with ionizable species), and unfortunately has a chance of affecting the spectra (both MS and UV-Vis) such that the peak matching method becomes more difficult to implement.

Still referring to FIG. 2, the detector 26 may include one or more spectral measurement devices suitable for use in any type of hyphenated technique. MS, FTIR, AES, UV-Vis, and any other type of detector or apparatus can be used in accordance with the teachings of the invention. As MS detectors are being multiplexed so that one instrument can collect four or more signals at once, such detectors 26 prove suitable for use in various embodiments. This follows because with the advent of multiplexed mass spectral detection, it is now possible to quickly analyze a given substance under multiple sets of conditions, using the same MS detector. In addition, as part of the teaching of the invention allows for detecting peaks between different runs as they are moved relative to each other between runs, it is advantageous for one detector 26 to be capable of observing multiple differing chromatographic conditions.

Generally, there is no universal spectral technique suitable for analyzing all possible categories of sample constituent components. Nuclear magnetic resonance depends on the presence of a NMR-active nucleus. Mass spectrometry depends on ionizability. UV-Vis spectroscopy depends on the presence of a chromophore. Thus, in order to maximize the success of detection and differentiation between multiple unknown species, it is useful to employ multiple detection techniques in order to ensure the success of the matching technique, and thus the component resolution techniques of the invention. Utilizing mass spectrometry in conjunction with UV-Vis spectroscopy affords two advantages over UV-Vis exclusively. The first is that components that have no signal in UV-Vis may have signal in MS, leading to the potential for detection. The second is that this is an orthogonal detection technique; components that may have the same UV-Vis spectrum may not have the same mass, enabling the system to characterize and differentiate between components.

Again referring to FIG. 2, in addition to the detector 26, an apparatus for collecting the eluant, not shown, would also typically be present in setup 20. The spectrochromatogram output data generated by the interaction of the detector 26 and the sample eluant is transmitted to a data acquisition/data processing device 28 for storage and/or processing. As multiple spectrochromatograms are generated under varying experimental conditions, the detector data is sent to the data processing device 28 for processing and peak/component matching steps along with the previously acquired spectrochromatogram data to achieve component resolution. The data processing device can be a general purpose computer or include a specialty processor. The method steps associated with NDMC and the MAP techniques are typically performed as part of a software package or program.

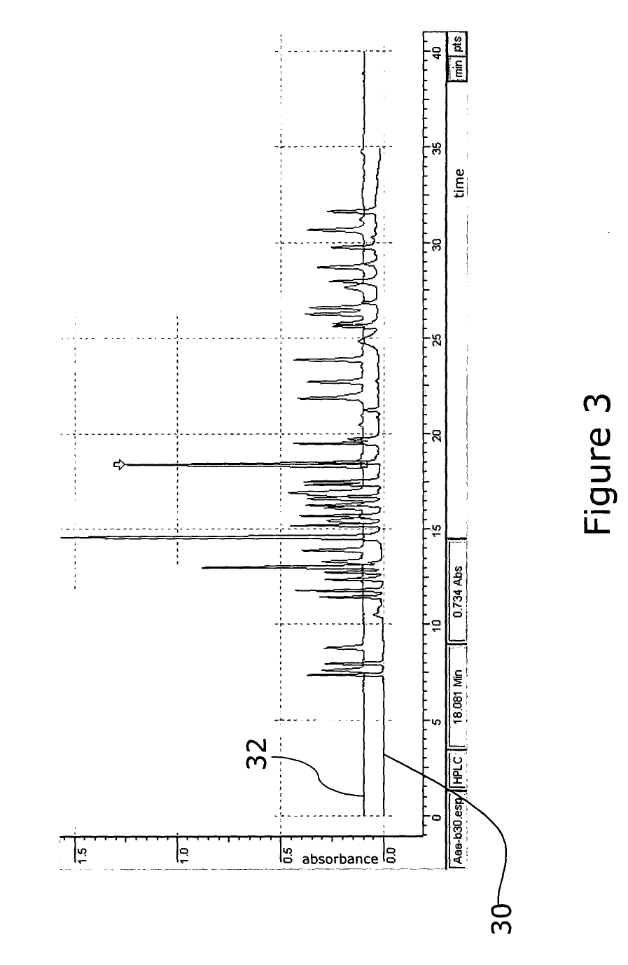

FIG. 3, shows a two-dimensional representation (an integral spectral signal) of portions of first and second spectrochromatogram data sets 30, 32 respectively obtained under a first set of chromatographic conditions and a second set of differing conditions. Given that the first set of data 30 and the second data 32 as well as the peaks associated with each of the respective chromatographic runs is for a single sample, it follows that the some or all of the peaks in the first data set 30 should correspond to the peaks in the other related data set 32. This follows because it is the change in experimental conditions that has caused a variation in the separation conditions, component retention time and the degree of component co-elution between two experimental runs. The reason that all of the peaks might not be correlateable between the two data sets results if one or more of the component compounds in the sample co-elute in one or both of the chromatographic runs. The example spectrochromatogram data sets representations shown in FIG. 3 correspond to a complex sample with many different yet similar components.

Tracking the peaks between different chromatographic runs using conventional experimental trials is difficult and time consuming. Thus, for rigorous modeling and experimental resolution of all the peaks using conventional techniques more than ten experiments might be necessary to study a complex sample such as shown in FIG. 3. This follows because the complexity of the sample may require optimizing multiple parameters for each component to separate without co-elution. Since changing each parameter requires at least two experiments, multiple parameters produce a lot of combinations and the amount of experimentation can be high. Clearly this is a time consuming process requiring a significant amount of resources. The NDMC techniques and MAP matching methods of the present invention can address such complex samples through an automated process that does not necessitate time-consuming method development or the complex instrumentation associated with two-dimensional chromatography.

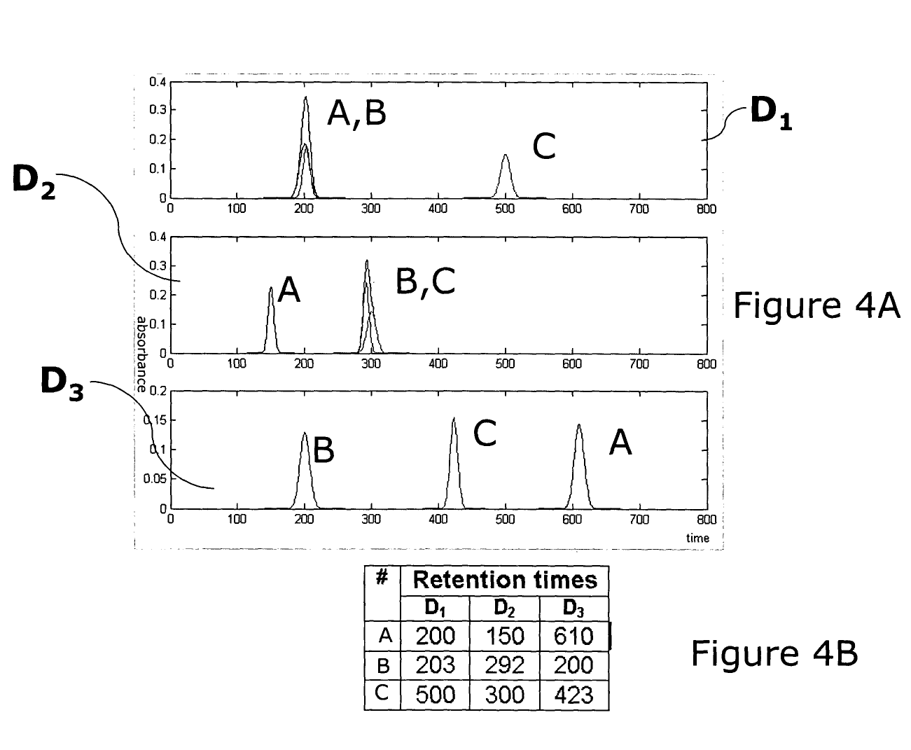

Prior to discussing the particulars of the peak matching methods of the present invention in more detail, let us consider the simplified example shown in FIGS. 4A and 4B. D₁ and D₂ correspond to two different experiments on the same mixture obtained under two different sets of chromatographic conditions. The mixture includes three components A, B, and C that are only partially resolved in either experiment. In experiment D₁, A and B are shown as overlapping peaks while component C is resolved. Yet, in experiment D₂, B and C are shown as overlapping peaks while component A is resolved. Upon comparing experiments D₁ and D₂, it is apparent that all of underlying component peaks move due to the changing conditions. If the movements of the peaks are quantified, a mathematical model can be built to predict their positions under new conditions, thereby providing an avenue to optimization. The only way to quantify the movements is to relate peaks between the different runs. In other words, peak matching should be performed using MAP or another suitable method known in the art. Once the peak movements are tracked, they can be used for optimizing separation conditions and achieving physical resolution of the components as shown in the resulting output D₃. FIG. 4B shows the after the results of the successful application of one of the peak matching methods of the invention. This is a table of each experimental run for each component A, B, and C as well as each components retention time in each run. Output tables as shown in FIG. 4B can be used to perform additional calculations regarding the resolved chemical components in the original sample. A natural way of representation of the peak matching results is such a table of retention times with the rows for components and columns for experiments or vice versa.

In theory, it is possible to distinguish and match even components that have zero chromatographic resolution (exactly co-eluting) in any given single chromatographic run. The relative motion of the peaks between the runs is sufficient to distinguish all of the peaks in a given example using aspects of the invention. In general, a component can be successfully matched even if its peak is overlapped by other peaks in every one of the chromatographic runs.

The NDMC analysis of a mixture can be accomplished by quantitative characterization of the mixture components. In the ultimate resolution, quantitation of a component means obtaining its absolute concentration profiles expressed in concentration units such as molar concentration. In conventional chromatography, however, quantitation is often limited to finding relative peak areas of the components that are then used as quantitative parameters of the mixture, rather than real concentrations. The potential to replace component concentrations by respective peak areas is based on the fact that absorptivities of most organic compounds are relatively close to each other. When precision requirements to estimating concentration are lower than variations in the component absorptivities, replacement of real concentrations by the peak areas is acceptable in one embodiment of the invention.

In this paragraph the absorbances and wavelengths related to UV-Vis spectroscopy are mentioned for demonstration purposes only. The same principles of the reduction of spectrochromatographic data can be used when other types of spectroscopy are applied as a detection technique. The terms “peak area” and “relative peak area” refer to a two-dimensional representation of a spectrochromatographic dataset that is a conventional flat chromatographic curve. Such a curve can be obtained by a reduction of the data when each spectrum is replaced by a scalar number. Depending on type of the reduction the following chromatographic curves are distinguished: integral chromatogram (each spectrum is replaced by its integral that is the sum of all absorbance values), maximum intensity plot (each spectrum is replaced by its maximum absorbance value), and single wavelength chromatogram (each spectrum is replaced by one of its absorbance values taken at the same single wavelength). These three types of reduced spectrochromatograms are of the most practical importance. However, other similar methods of data reduction can be applied.

The term “peak area” is defined as an area limited by the chromatographic curve on top and by zero or a user-defined baseline below and measured in a time region including significant component signal. “Relative peak area” is a ratio of the peak area to the area under the entire chromatographic curve and above zero or a user-defined baseline.

The peak area of a component is calculated from its individual concentration profile. A general approach to finding the concentration profiles includes a curve resolution stage. Once the component spectra and their concentration profiles are successfully resolved, obtaining the component peak areas is trivial provided that every resolved pair of the component spectrum and concentration profile are properly mathematically treated with respect to a chosen type of the reduced chromatogram as described above.

In some cases it is possible to resolve concentration profiles of a single peak or selected peaks without performing full curve resolution. This requires some additional conditions to be met. One of the most practically important cases is a peak that is completely resolved (pure) in at least one of chromatographic runs. Purity of a peak means that it is not mixed with other signals and its concentration profile corresponds to a pure component. Moreover, it provides the component spectrum that can be a scan taken close to the peak maximum or an average signal on a region.

There are special methods based on multivariate analysis to access and extract peak purity information from spectrochromatographic data that are known to those skilled in the art and suitable for use in aspects of the invention. However, if the components are successfully matched between the runs in a series, pure components can be detected by an operator or software in a simplified manner based on inspection of component retention times against the flat chromatographic curve.

If a pure peak is present in a spectrochromatogram, its area and relative area can be directly measured. Applying an additional assumption of the constancy of the injection volume, the relative area of the component can be calculated in other spectrochromatograms. If the latter assumption is not true, the task of the component quantitation (using its known spectrum only) in other runs where it is overlapped does not have a unique solution. In theory, in some cases it can be still solved using some multivariate approaches and applying additional constraints.

Another important instance of partial resolution is the resolution of co-eluting components with known spectra. If spectra of two or more co-eluting components are known, their concentration profiles can be resolved from an overlapped group of peaks in the raw data. As mentioned above, sometimes a component spectrum can be taken from another chromatographic run where the corresponding peak is fully resolved.

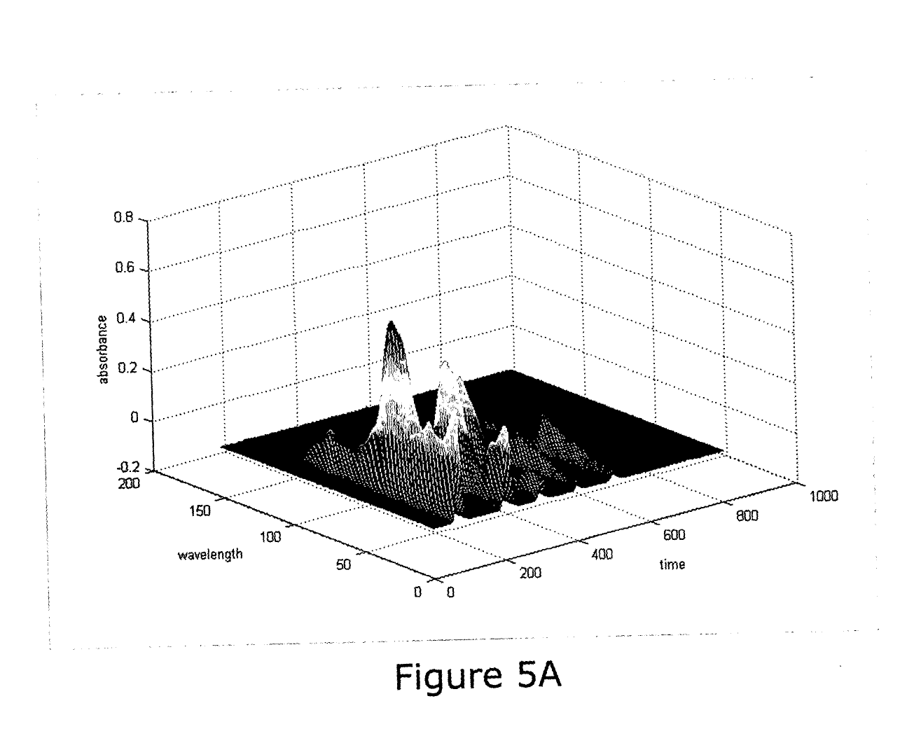

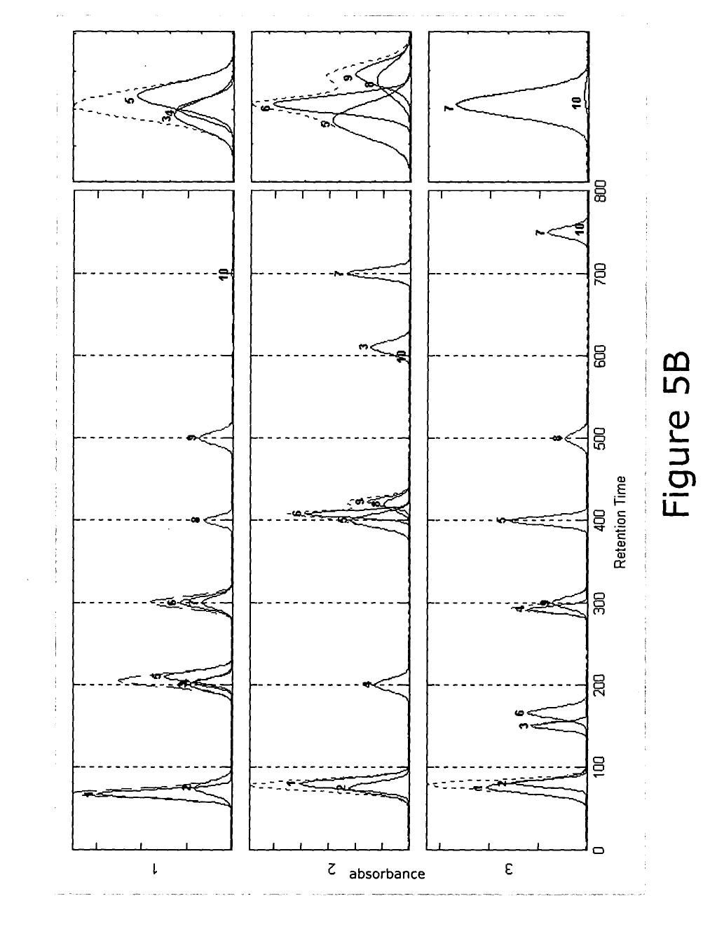

Turning to FIGS. 5A-5B, in order to demonstrate the features of the peak matching method, data simulating the analysis of a mixture of ten homologically related compounds (phenanthrene and its monosubstituted derivatives) is provided. FIG. 5A shows a representation of one of the spectrochromatograms visualized as a 3D surface according to one embodiment. These compounds are labeled in FIG. 5B as follows (1) 9-carboxyphenanthrene; (2) 9-cyanophenanthrene; (3) 9-bromophenanthrene; (4) phenanthrene; (5) 9-acetylaminophenanthrene; (6) 2-acetophenanthrene; (7) 2-acetylaminophenanthrene (8) 3-acetophenanthrene; (9) 3-acetylaminophenanthrene; and (10) 3-hydroxyphenanthrene. This data is discussed in more detail in the examples section provided below.

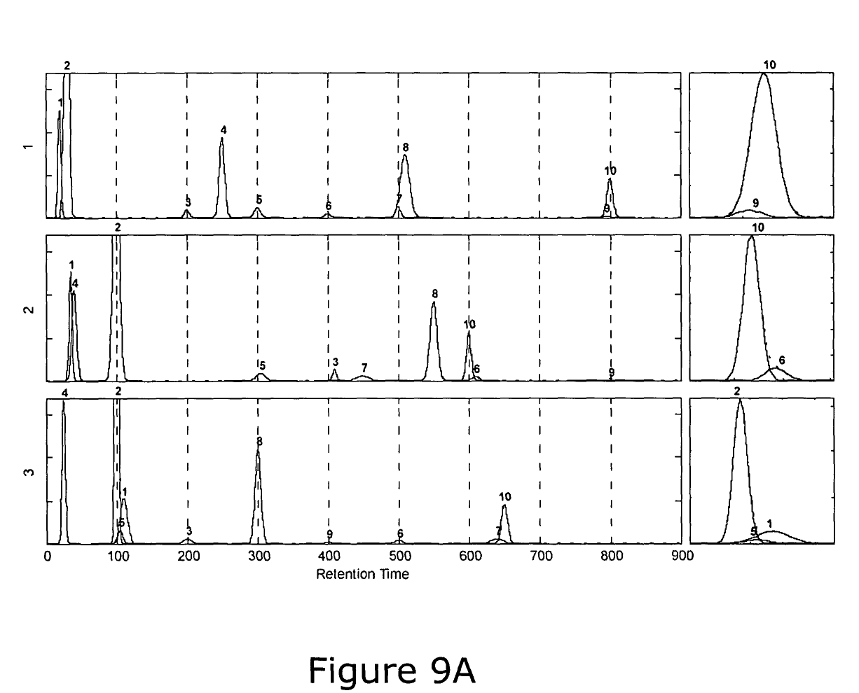

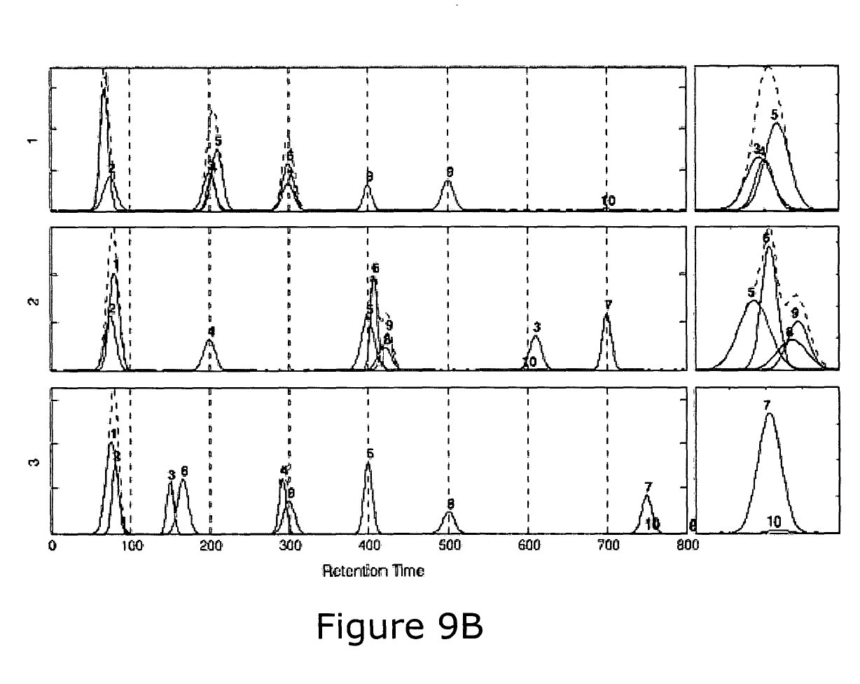

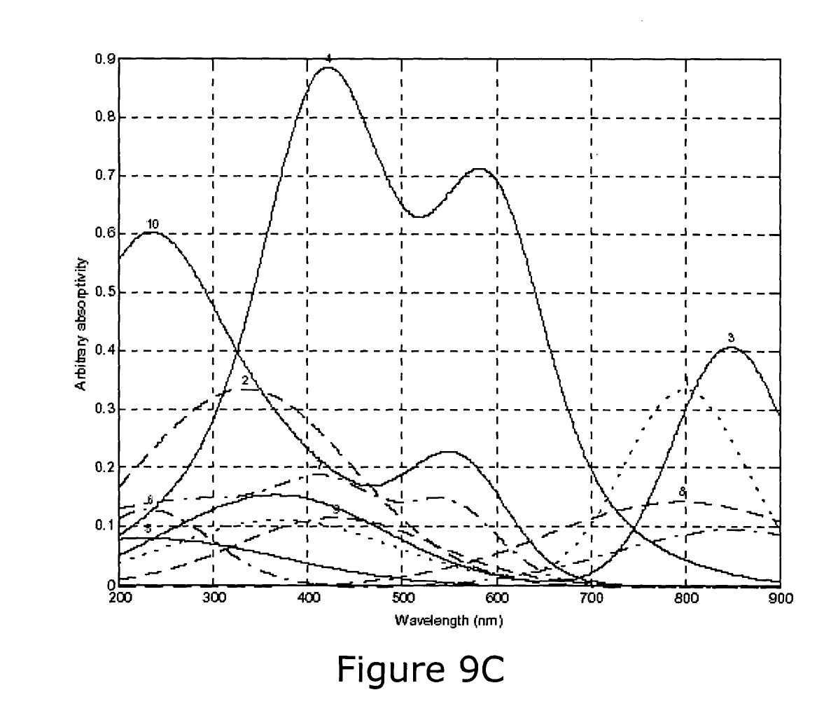

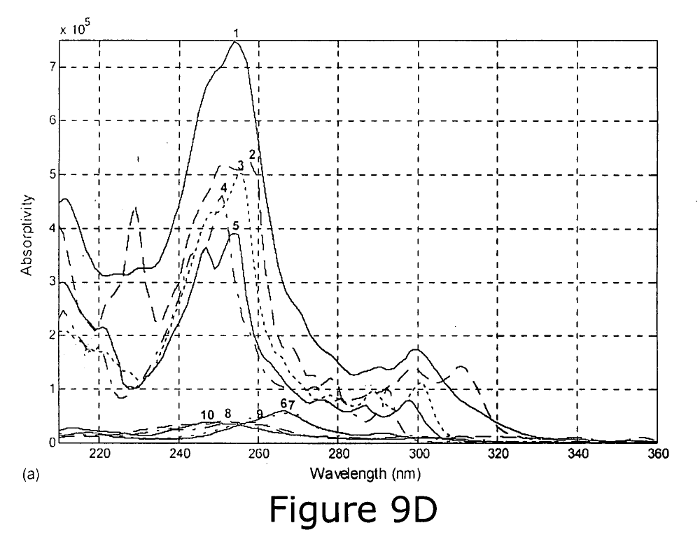

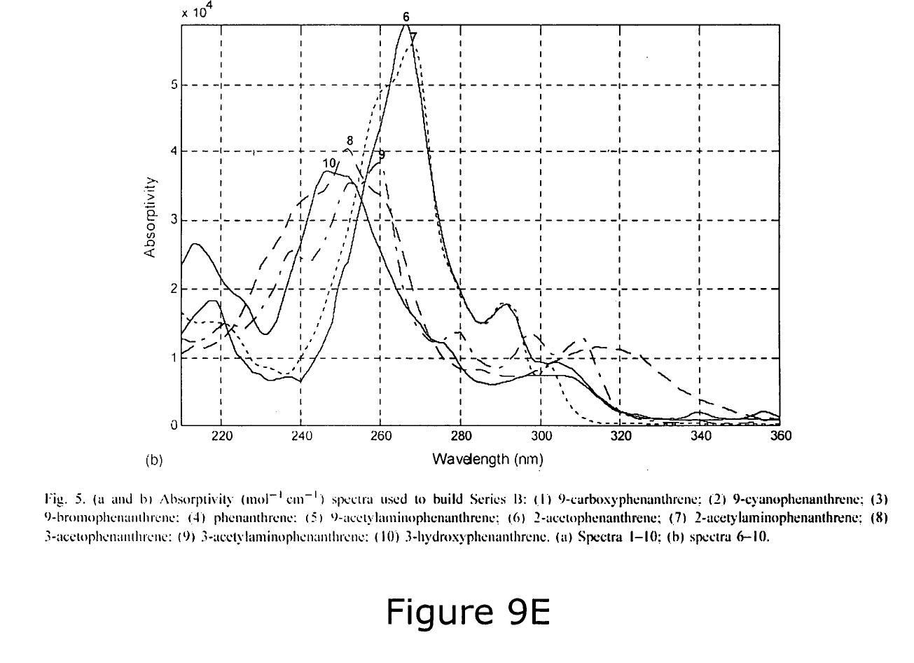

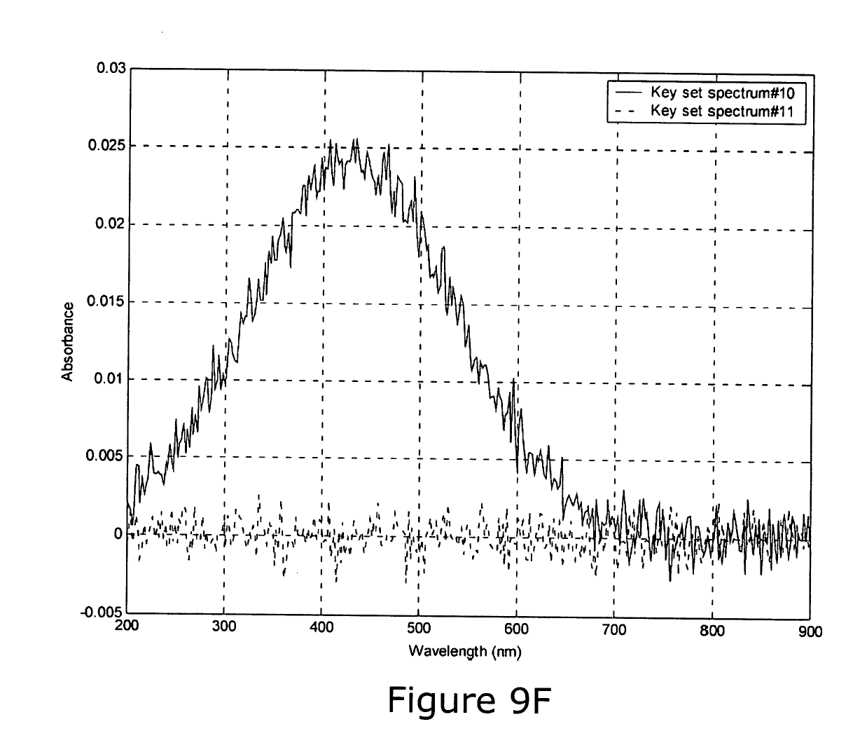

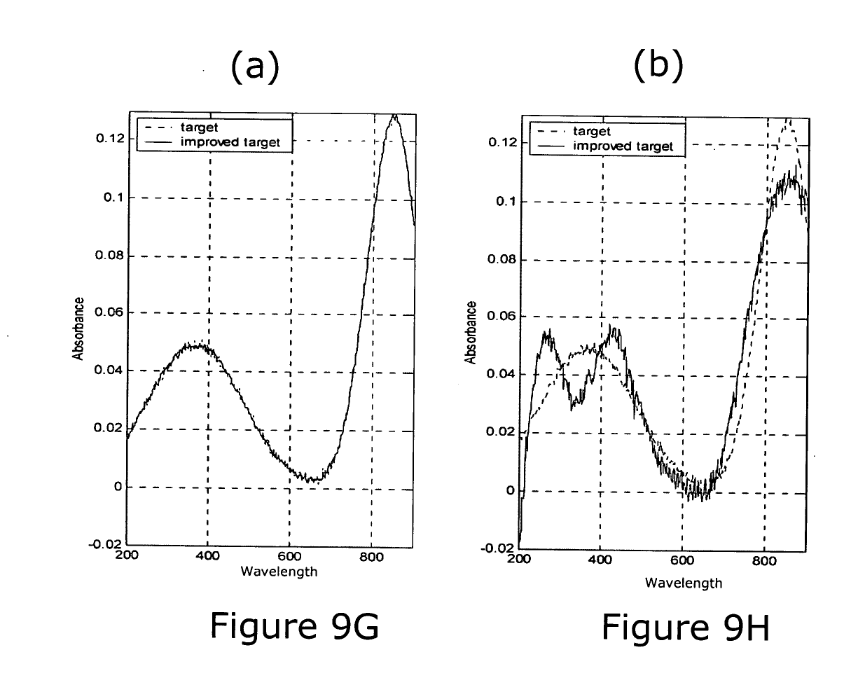

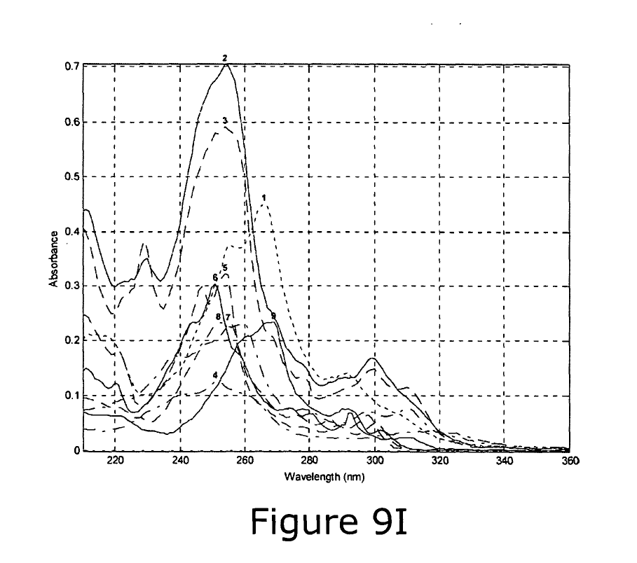

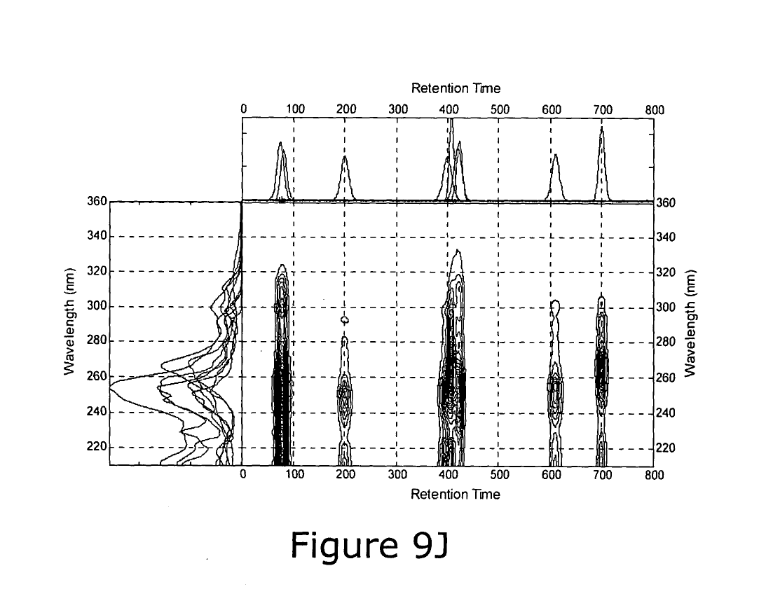

Real UV-Vis spectra were used to build the data as shown in the plot in FIGS. 5A-5B. As shown below in more detail on FIGS. 9D-9E, sometimes differences between spectra are small. Concentration profiles were constructed from Gaussian peaks to obtain peak patterns of desired complexity. Datasets were simulated as shown in FIGS. 5A and 5B. Turning to the FIG. 5B most of the peaks experience some degree of overlap. The complexity of the test sample and problems of co-elution are illustrated by: situations of two, three and four overlapped peaks; a pair of the same components is mixed with each other in every dataset; and the presence of embedded and even exactly co-eluting peaks.

The peak matching methods of the invention were tested on this set of simulated data modeling a chromatographic separation of a mixture of ten components of the same homology: phenanthrene and its nine monosubstituted derivatives. The MAP techniques were able to match components within this data set. Given the complexity of the differing views shown in exemplary FIG. 5B and similarity of the component spectra seen in the FIGS. 9D-9E , it is clear that the resulting spectrochromatographic data in various experiments is quite complex and difficult to analyze.

Mutual Automated Peak Matching is a method based on multivariate analysis and applied to a series of several (two or more) spectrochromatograms of the same mixture of compounds (known or unknown) obtained under different separation conditions (temperature, pH, solvent composition, gradient, and column). One goal of the method is to find retention times related to the same mixture components in different spectrochromatograms. Additionally, the number of mixture components is obtained. Peak matching results can be represented as a table of retention times where the rows correspond to spectrochromatograms and the columns correspond to mixture components (or vice versa).

The following assumptions are imposed on the data by the steps used in the MAP method:

(1) UV-Vis spectra of components obey Beer's law for UV-Vis spectra; in general, the dependence of spectral response on a component concentration is described by a linear function;

(2) the spectrum of an analyte is constant during the same chromatographic run as well as between different runs in one series within experimental error; and

(3) the spectra of different components are significantly different compared to experimental error, more generally, any pure component spectrum is not a linear combination of others.

Though these assumptions have an underlying theoretical basis, experimental data may not always abide by these requirements. This, however, is not a reason to automatically disregard this method. Its applicability should be considered for each individual case separately taking into account the properties of the system under study and the deviation degree.

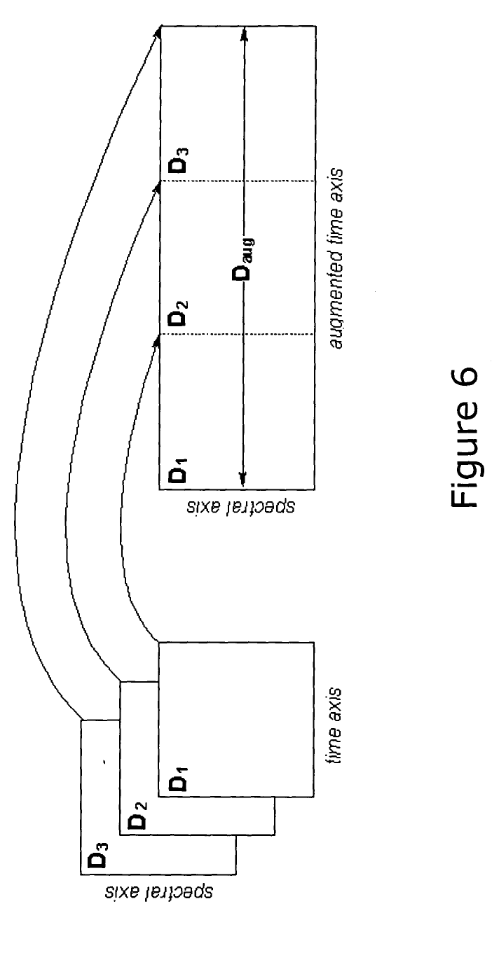

Carrying out the MAP method of the invention is based, in part, on the assumption that the component spectra stay always the same during the experiment as well as between different datasets. This makes it possible to connect all matrices into one larger augmented matrix as if it were a single large chromatogram with a joint evolutionary temporal axis. This concept is represented visually in FIG. 6.

The study of a series of spectrochromatograms is a three-way data analytical problem where several matrices forming a three-dimensional data array are simultaneously involved in analysis. However, because component spectra are supposed to be the same, its solution can be transformed into a two-way plane by connecting individual chromatographic runs into a single augmented matrix with a joint evolutionary axis (See FIG. 6). The augmented data matrix D_{aug} is composed of individual datasets D₁, D₂, . . . , Dₖ (spectra in columns) as shown in Eq. 1.

D_{aug}=[D₁ D₂ . . . Dₖ] (Eq. 1)

Whereas spectral axes of all matrices in a dataset should be the same in order to make augmentation possible, time axes may vary. Typically, they are simply joined together to form a new augmented time scale.

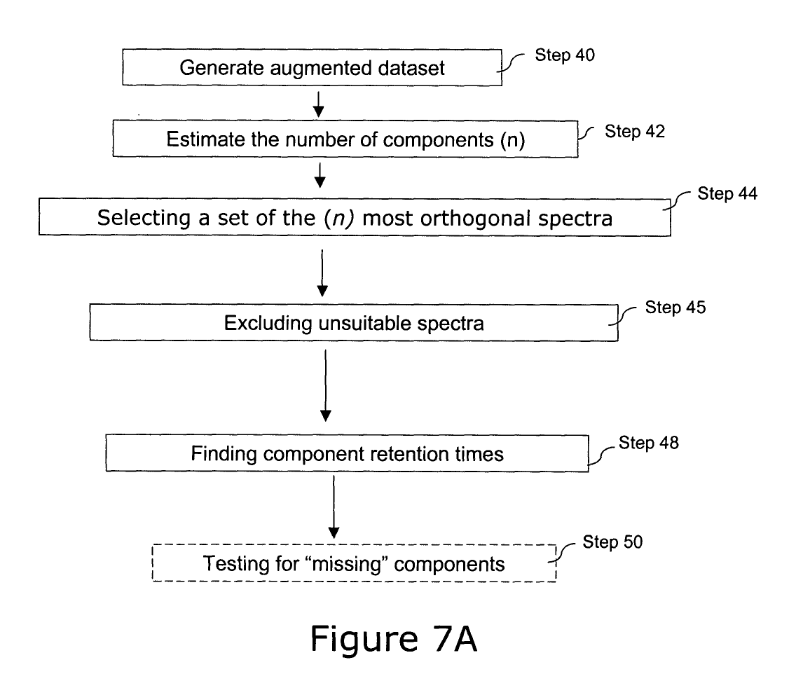

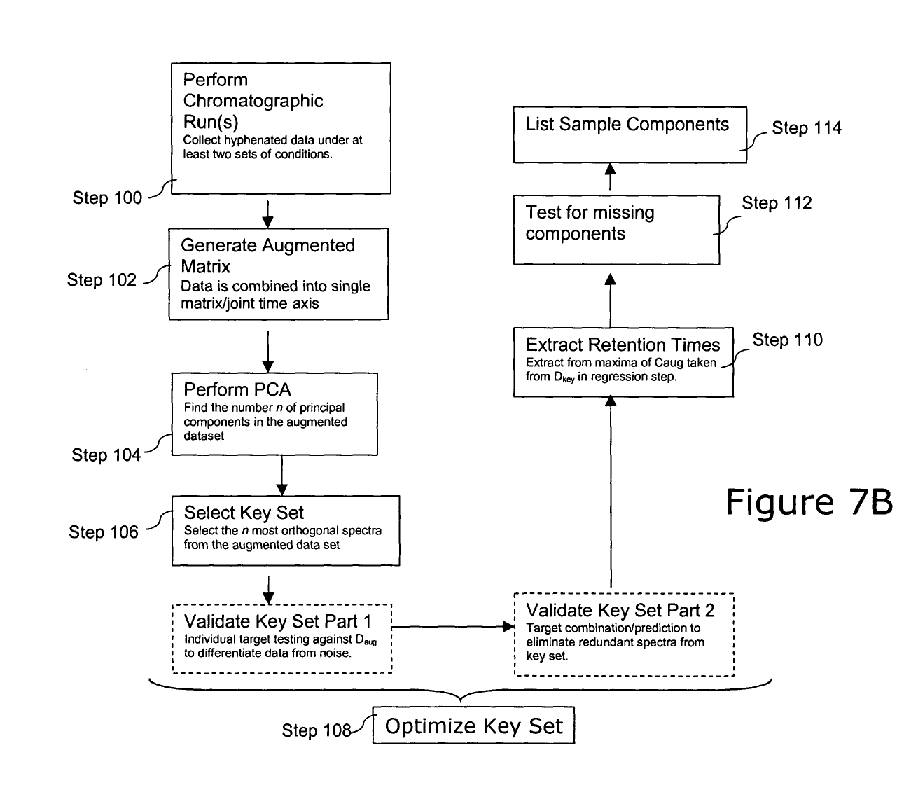

Turning to FIG. 7A, the steps of one embodiment of the MAP method are described at a high level. Generally, the problem the MAP method is designed to solve is identifying the data associated with one particular component (typically a peak or signal) across multiple experiments performed on a sample containing the component. When multiple chromatographic runs are performed on the same sample, it is desirable to identify which portion of the experimental data (peaks or signals) obtained for each run relates to that one component. This is complicated by multiple components co-eluting at the same time such that matching up which portions of a large pool of data for multiple experiments corresponds to the specific component becomes difficult.

Initially, an augmented data set, typically in the form of an augmented data matrix D_{aug} is generated (Step 40). This step involves creating an augmented dataset by means of merging all spectrochromatograms of the series side by side along the time axis. Generating an augmented data set is useful because all of the data relating to all of the components obtained at different points in time for a given sample are represented in one mathematical form that is readily manipulated. In order to conduct further analysis on the sample, it is useful to obtain an estimate for the number of components (n) that comprise the sample. In some embodiments, an estimate of the number of components (n) in the sample is obtained (Step 42) through PCA. In some embodiments, estimating the number of components (n) can be obtained by other methods known in the art or by the chromatographer.

At this point in the method, the physical data is represented in an augmented form and an estimate for the number of components (n) in the sample of interest is known. Selecting a set of the (n) most orthogonal spectra (Step 44) is then initiated. The selection of the orthogonal spectra can be accomplished by IKSFA or other suitable methods as known in the art. Selecting orthogonal spectra generates a subset of data that has a relationship with the individual components in the sample such that statistical operations can be performed using the set of orthogonal spectra (key set) to extract information from the augmented data matrix. As this key set is used to model the augmented data it is important for it to contain possible minimum of the noise and error and is optimal for modeling. Thus, the next step is to exclude unsuitable spectra (Step 45). In various embodiments, different techniques can be employed to ensure that the key set of spectra is not compromised by noise and that the number of the spectra in the set is not artificially high. Once a suitable key set has been obtained it may be used in conjunction with the augmented data set to extract information about the components such as determining component retention times for each component with respect to each of the original spectrochromatograms (Step 48) used to generate D_{aug}. Optionally, missing components testing may be conducted in various embodiments (Step 50). The specifics of these methods are discussed in more detail below following the discussion of a more detailed embodiment in FIG. 7B.

FIG. 7B illustrates another embodiment of a method of the invention in more detail. Initially chromatographic run(s) are obtained through experimentation and spectrochromatographic data is collected under at least two sets of conditions (Step 100). An augmented matrix is generated with data combined along a single matrix/joint time axis (Step 102). PCA is performed to find the number n of principal components in the augmented data set (Step 104). A key set is selected; this set is typically the n most orthogonal spectra from the augmented data set (Step 106). Generally it is desirable to optimize the key set (Step 108). This can be done in two parts, both of which are optional in some embodiments. One step (Part 1) of optimizing the key set is validating the key set by individual target testing against D_{aug} to differentiate data from noise. The other step (Part 2) is target combination/prediction to eliminate redundant spectra from the key set. In this embodiment of the invention the next step is to extract retention times; they are extracted from maxima of C_{aug} taken from D_{key} and D_{aug} in a regression process (Step 110). Testing for missing components, that is sample components that were not detected in some runs while was present in others, can then be conducted (Step 112). These various steps can be iterated as necessary in various embodiments. Then the components in the sample that have been distinguished and characterized by the steps of the method are listed in a suitable format (Step 114).

Now we explore the steps of one embodiment of the MAP method in more detail. After the augmented data set has been generated, the next step of the method is the determination of the number of system components (factors). Ideally, the number of factors corresponds to or is greater than the number of chemical components in the sample of interest. The number of factors should be determined on the augmented data matrix because the same matrix is used for further calculations. The total number of components is determined by PCA of D_{aug} and based on analysis of products of data matrix decomposition (Eq. 2):

D_{aug}=R_{abs}C_{abs}+E (Eq. 2)

Where R_{abs} is an abstract row matrix (scores) and C_{abs} an abstract column matrix (loadings). The matrix E consists of the extracted error. Thus the augmented data matrix formed from the individual spectrochromatogram data can be decomposed into the product of two matrices and a matrix of error terms. These various matrices can be manipulated and operated upon by various derived or calculated data sets to reveal information about the number and retention times of the chemical components present in the analyzed sample mixture. These features of the invention are discussed in more detail below.

This part of the MAP method employs PCA using singular value decomposition or non-iterative partial least squares on the augmented dataset to perform the decomposition in accordance to the Eq. 2. Only the first n factors (n first columns of R_{abs} and n first rows in C_{abs}) are retained as primary factors necessary for modeling the data. Subsequent factors do not contained anything but experimental error and should be removed. n is then taken for the number of system components. Numerous approaches can be applied to determine the number of primary factors n. Methods based on experimental error such as real error (RE) and imbedded error (IE) functions are generally preferred. These methods provide a cut-off level at the proper n value. The RE function requires the experimental error residual standard deviation (R.S.D.) to be known, providing a cut-off level at a proper number of factors. The IE is based on detecting the function minimum corresponding to the best model. Both techniques produce excellent results when the error is represented by noise having distribution close to normal. For more detail on the RE and IE functions, see E. R. Malinowski, Factor Analysis in Chemistry, third ed., Wiley/Interscience, New York, 2002, the disclosure of which is incorporated by references in its entirety. The factor indicator function (IND) can also be used to select the proper number of factors in various embodiments. For more detail on the IND function see E. R. Malinowski, Anal. Chem. 49 (1977) 612., the disclosure of which is herein incorporated by reference. Cross validation and other methods can also be used to estimate the n.

Estimating the number of components n is necessary since it is used by the IKSFA method discussed in more detail below. PCA detects the number of components in an abstract mathematical sense and, for real world systems, it may differ from a chromatographer's estimates. This is discussed in more detail below, the present approach is relatively tolerant of an error in the number of factors found at the PCA stage. Moreover, the PCA result need not necessarily coincide with the final number of components produced by the peak matching method. Factors attributed to non-detectable or non-analyte components as well as the noise could be detected and removed at later stages. Considering this, it may be relevant to increase n by a few extra factors in the model prior to moving to the next step. Individual datasets D₁, D₂, . . . , Dₖ can be factor analyzed as well to check the data integrity.

The next part of the method relates to determining a set of spectra that satisfy specific conditions. Specifically, the goal of this step of the method is to select a set of the n most orthogonal spectra, that is the spectra obtained from the individual spectrochromatograms that are the most different from each other. This is typically achieved by performing IKSFA on the columns of the augmented dataset to select a set of the n most orthogonal spectra. For more information on IKSFA see K. J. Schostak, E. R. Malinowski, Chemom. Intell. Lab. Syst. 6 (1989) 21, the disclosures of which are herein incorporated by reference) In various embodiments of the invention a modification is made to the original IKSFA method that includes omitting the normalization of the abstract score matrix. In other embodiments, orthogonal projection approach (OPA), simple-to-use interactive self-modeling mixture analysis (SIMPLISMA), and the original IKSFA method can be used to select a set of orthogonal spectra in various embodiments.

The MAP algorithm makes use of the key set approach for data modeling. n spectra are selected from the augmented data matrix (n is the number of components detected in the previous stage) to become the axis of the new reduced data space. For successful modeling these spectra should be the most informative set representing all the important variance in the original data. In a mathematical sense, this is the set of the most orthogonal spectra.

The matrix D_{aug} is subjected to IKSFA to determine a set of the n most orthogonal spectra along the augmented evolutionary axis. To remain consistent with the traditional notation, the method synopsis below is given for finding a key set of data rows. Applied on a transposed matrix, it will similarly produce a solution for typical columns.

IKSFA finds typical data rows by analyzing the matrix of scores for n abstract factors. Each row in this matrix is first normalized to unit length to eliminate a factor of intensity. The method results in indices of the n most orthogonal rows in the normalized scores. Corresponding rows of the original data matrix form the required key set.

As discussed above the IKSFA approach is modified in various applications of the steps of the MAP method. Specifically, the modification requires that the normalization of the abstract score matrix used by the key set selection method not be performed as recommended by the classic IKSFA approach, resulting in a modified IKSFA technique. This change has a two-fold purpose. First, due to this alteration, the components gain greater weight at greater intensity and are reliably detected by the method. In addition, the absence of normalization prevents the exaggeration of noise factors that introduce additional error into the model. Pure noise poses a serious problem to the IKSFA procedure because the normalization gives the noise data equal weight with real data. Therefore, preliminary screening of data with the removal of spectra with a root mean square (rms) response less than five times the real error is strongly recommended by the regular method. Omitting the normalization step may bring about some losses of method sensitivity to low-intensity components. At the same time, it provides more reliable detection of the main mixture analytes and some simplification of calculations by omitting data pre-processing stages.

As a consequence of being a combination of the most “different” spectra, each of the key spectra is the closest approximation of a pure component spectrum. If the key spectra are selected to be the most different from each other, it follows that given the sample of interest is made up of different components the most different spectra would tend to approximate those corresponding sample component spectra. At the same time, the modified IKSFA method tends to select spectra in maximum positions of individual peaks. That is, to select spectra in the maxima positions of actual component concentration profiles, even if those are peaks significantly overlapped. In other words, spectra with the highest content of analytes are detected. The main advantage of using the augmented data matrix, instead of analyzing the datasets separately, is that the purest peaks of every component among all the experiments are detected in a single step. Note that finding actual pure spectra is not required by the method. This capability to detect hidden peak maxima is an obvious advantage of the modified IKSFA approach.

Once the modified IKSFA approach or other suitable technique for selecting the n orthogonal spectra is performed, the next step of the method involves refining that set of selected spectra. This portion of the method is referred to as key set refinement. This follows because typically the spectra resulting from IKSFA do not necessarily represent an optimal set of factor axes spanning the space of experimental data most effectively. If the number of key spectra is less than the actual dimensionality of the data space n, the model is underdetermined, and some useful information may be lost. In case n is, to the contrary, overestimated, spectra modeling experimental error may be introduced, leading the model to degradation.

Because the model size n is often task-dependent and to some extent subjective, its exact evaluation at the PCA stage is not always possible. To avoid obtaining an underdetermined model it is advisable to add one or two extra factors to the number obtained from PCA. The key set refinement procedure enables the detection and exclusion of excessive and “bad” spectra as described below. An iterative key set optimization approach based on tools provided by target factor analysis is used in various embodiments as follows.

First, one must exclude factors modeling mostly noise as well as outlying measurements, as experimental artifacts. Spectra of these two types are unique to the whole dataset and can be easily detected by various procedures known as target testing. Various functions can be used as a quality control to rate the suitability of the chosen spectra.

In various embodiments of the key set refinement procedure the SPOIL function is used to accomplish this quality control function. The SPOIL function can be defined as the ratio of the real error in the target vector (RET) and the real error in the predicted vector (REP). The SPOIL function's value is a reflection of how much error is present in the target relative to the data matrix. In fact, the SPOIL function provides a “measure of quality” of the target for reproducing the data matrix. The larger the value, the lower the quality of the data matrix reproduction. A guideline criterion was suggested that prompts for exclusion (SPOIL>6) or acceptance (SPOIL<3) of a target being tested. An intermediate function value requires the attachment of additional information to make a well-grounded decision. For details on the SPOIL function definition and usage, turn to E. R. Malinoski, Anal. Chim. Acta 103 (1978) 339, the disclosure of which is herein incorporated by reference.

Each spectrum in an initial key set is individually target tested on abstract data space of the augmented dataset with n factors (n is the number of key spectra). R_{abs} obtained at the previous PCA decomposition (Eq. 2) is used for testing. In cases where the SPOIL value exceeds 6, n should be decremented by 1 and the key set recalculated for n−1 factors as described above. The testing procedure is repeated until all of the remaining spectra satisfy the SPOIL condition. Since SPOIL is an empirical parameter, its upper cut-off value may be varied by an operator to suit a specific data analysis situation. This feature of the MAP method is included for eliminating key set spectra representing noise and outliers.

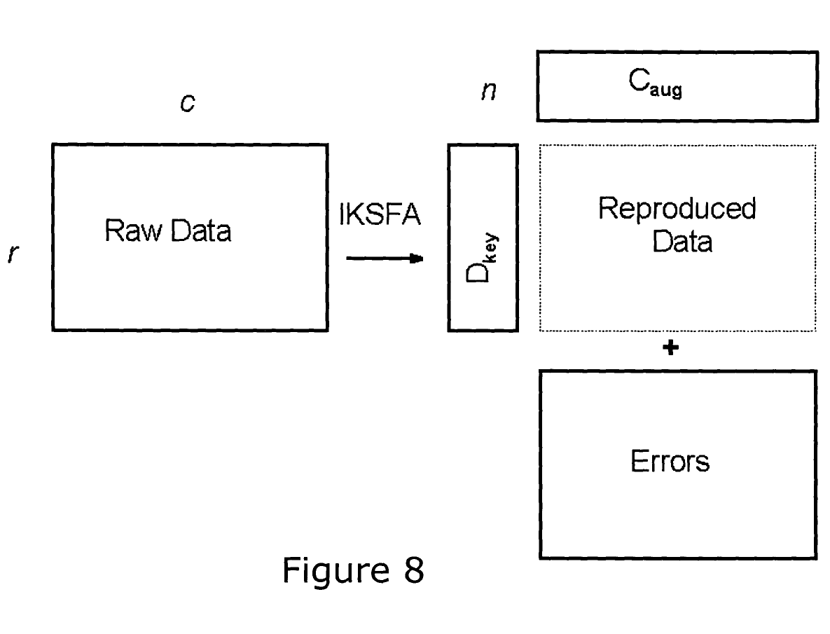

Absence of unique spectra in a key set, by itself, does not guarantee that the remaining spectra represent the optimal key set because it may still contain some redundant spectra spoiling the model. The second procedure of the key set refinement stage is direct examination for its being overdetermined in an iterative target combination cycle as follows. The interrelation of the various matrices discussed in relation to key set refinement and representations of the subsequent steps of one embodiment of the MAP method as discussed below are illustrated at a general level in FIG. 8. In FIG. 8, one matrix, D_{key} contains a key set of the raw spectra and another one—a complementary set C_{aug} obtained from D_{key} by means of a regression procedure with the augmented raw data. As discussed in more detail below.

First, each of n spectra from D_{key} is individually target tested on R_{abs} (the n-factor scores of D_{aug} as defined by (D_{aug}=R_{abs}C_{abs}+E (Eq. 2)), resulting in a set of transformation vectors t₁, t₂, . . . , tₙ. (Note, n stands for a current number of spectra in the key set left after previous elimination steps. The number of factors retained in the score matrix used for target analysis should be the same.) These transformation vectors are used to form a transformation matrix T. Multiplication of the inverse of the transformation matrix T=[t₁ t₂ . . . tₙ] by the loadings of D_{aug}, transforms the abstract column matrix C_{abs} into the physical space, producing an augmented estimate of predicted concentration profiles C_{aug}, complementary with spectra in D_{key} (as shown in FIG. 8). T contains numerical coefficients that connect the abstract space of PCA factors and the physical space of spectra and concentration profiles.

T¹C_{abs}=C_{aug}=[C₁ C₂· . . . ·Cₖ] (Eq. 3)

where C₁, C₂, . . . , Cₖ are the portions of the augmented predicted concentration profile C_{aug} corresponding to individual experiments D₁, D₂, . . . , Dₖ.

An optimal key set can be defined as one producing a minimum prediction error as expressed by (Eq. 4).

∥D_{key}C_{aug}−D_{aug}∥²=minimum (Eq. 4)

Straight double brackets designate the norm of a matrix. Based on this definition, key spectra which are “bad” for data reproduction can be detected and removed from D_{key} by the following procedure. The first spectrum is excluded from D_{key} and concentration profiles are calculated for this truncated set. When deleting the spectrum results in an increase of the prediction error, calculated by the left side of the expression (4), this spectrum is considered significant for the model and should be kept. In the same way the second, third, etc. spectra are consecutively deleted followed by the above check. When deletion of a spectrum of D_{key} leads to an improvement of the model decreasing the prediction error, the whole key set is recalculated for n−1 factors. The full cycle is repeated until all n spectra become useful for the model. That is, the procedure is repeated until all spectra in the key set are found to be useful for the modeling of the augmented data.

The target combination step also serves to confirm that the selected key set of spectra adequately reproduces the original data and that the error defined by (Eq. 4) is meaningful. Eventually, it is expected that every spectrum of the refined D_{key} will correspond to an individual component of an analyzed mixture. Note, however, that a drifting baseline and other non-analyte factors possibly present may result in an increase of the model size. Therefore, it is always recommended to inspect D_{key} and C_{aug} visually in order to reveal such “ghost” factors and ignore peak maxima produced by them.

In practice, the stages of finding a key set and its refinement are compiled into a single methodic step. Here the separation was applied to emphasize the significance of key set validation prior to starting the peak analysis.

The next portion of an embodiment of the MAP method relates to determining component retention times. Retention times of components are obtained from C_{aug}. Component retention times are found as indices of maxima Cⱼ the portion of C_{aug} related to the jth experiment. For this purpose, it is split along the augmented time axis onto submatrices C₁, C₂, . . . , Cⱼ, . . . , Cₖ corresponding to k individual experimental runs D₁, D₂, . . . , Dⱼ, . . . , Dₖ. Each of these sets of derived experimental run data, D₁, . . . , Dₖ. . . , corresponds to one of the original spectrochromatographic runs that were initially used to generate the augmented data. Every Cⱼ includes n rows related to the spectra in D_{key}. Index of a maximum in ith row of Cⱼ represents a least-square estimate of the retention time of ith component in ith dataset.

To demonstrate the main concept behind collecting retention times as maxima of augmented concentration profiles resulting from the regression, first consider a simpler example of a single chromatographic run. In a successful key set, every spectrum represents a component of the analyzed mixture. In an ideal case, where each of them is a pure component spectrum, the regression will result in estimates of actual concentration profiles of the analytes. It is not expected that only pure spectra will be found. However, it is possible that the spectra that were selected were close to the maxima of the actual component peaks, which may be implicit because of an overlap. In the latter case, shapes of regression-resolved concentration profiles may be distorted because of a mathematical ambiguity of the system. However, the profile maxima experience the least bias and their indices still can be taken as retention time estimates. In the system, D_{key} contains spectra being a key set for the whole joint data matrix D_{aug}. Nevertheless, it is logical to suggest that the rows in C_{aug} reveal maxima of component peaks in every submatrix Cⱼ representing an individual run. Consequently, C_{aug} comprises retention time estimates of all mixture components in each run, no matter which Dⱼ gave birth to a spectrum of D_{key} responsible for a particular component.

These results can be represented as a table with experiments for columns and retention times of a component in each row. Thus, spectrochromatographic runs can be obtained for sample of a mixture where components co-elute and their retention times are unknown and the application of the MAP method to that data generates retention times for each component independent of the co-elution of various components by operating on the initial data.

Component retention times are calculated as maxima of C₁, C₂, . . . , Cₖ resulting from de-augmentation of C_{aug} that is an estimate of augmented concentration profiles obtained in a regression step using the refined key set. The previously refined key set is used to obtain the transformation matrix T. Thus the relationship is as follows

[C₁ C₂ . . . Cₖ]=C_{aug}=T⁻¹*C_{abs}

Thus C₁, C₂, . . . , Cₖ are portions of the augmented concentration profiles corresponding to individual spectrochromatograms. Since a maximum point is always found, the table of peaks compiled in this way will not reveal if a particular component is actually absent in one or more spectrochromatograms of the series while being detected by others. This inconsistency may be, for example, a result of an incomplete run when some components stay in the chromatographic column after analysis and not being detected; hence their signals are not present in the resulting spectrochromatogram. The next stage serves to confirm the actual components and detect missing ones.

The next step of the MAP method relates to testing for missing components. PCA is separately performed on each spectrochromatogram and each of the n spectra of the refined key set is target tested on n-factor abstract spaces of individual spectrochromatograms. Various statistical criteria such as real error in the target (RET), SPOIL, F-test can be used to judge the presence or absence of a component in a spectrochromatogram. Once the i-th component spectrum is found to be absent in the j-th spectrochromatogram, the corresponding retention time obtained in the previous step should be cleared in the corresponding cell of the resulting table.

At this stage of the MAP method, retention times found should be considered as candidate peaks since the same component may be present in one experiment and have no signal in another (e.g. as a result of incomplete analysis), but the peak table is always produced. To confirm the presence of a component in a certain experiment, key set spectra are individually target tested on separate datasets D₁, D₂, . . . , Dⱼ, . . . , Dₖ. If experimental error is known, real error in the target (RET) allows one to judge the presence or absence of a tested spectrum in the abstract space of another dataset. When a component is missing in the space of Dⱼ the RET will be significantly higher than both the experimental error and RETs of testing the same spectrum on other datasets where the corresponding component is present. In case of unknown experimental error, other statistical criteria such as the SPOIL function or F-test calculations can be applied. Comparison of concentration profiles in the Cⱼ portion of C_{aug} with their target-improved analogs from individual experiments can also provide a relevant basis for detecting a missing component.

The component number and retention times found by means of the present MAP peak matching technique can be used for further characterizing the mixture sample. The analysis may be completed by decomposition of data matrices onto spectra of individual components and their concentration profiles. This extension of the MAP method relates to curve resolution. Curve resolution aims at achieving an ultimate solution, i.e. the reproduction of all spectra of separate components and their concentration profiles. This curve resolution can be performed by Alternating Least-Square Multivariate Curve Resolution (ALS MCR) on an augmented data matrix. (See R. Tauler, A. Izquierdo-Ridorsa, E. Casassas, Chemom. Intell. Lab. Syst. 18 (1993) 293, the disclosure of which is herein incorporated by reference and see R. Tauler, E. Casassas, A. Izquierdo-Ridorsa, Anal. Chim. Acta 248 (1991) 447, the disclosure of which is herein incorporated by reference.

Obtaining quality initial estimates of spectra or concentration profiles to input into the iterative improvement process is, probably, the most problematic stage of most self-modeling curve resolution techniques. Initial estimates of concentration profiles can be obtained from available component retention times using an approach proposed in B. Vandengniste et al. Anal. Chim. Acta 173 (1985) 253, the disclosure of which is herein incorporated by reference, as a result of target transformation of uniqueness vectors. Uniqueness vectors are composed of unity values in positions corresponding to the retention times of components, produced by the present MAP method, and zeros elsewhere. Accordingly to ALS MCR pure spectra and profiles are iteratively improved by least-square calculation while subjecting the solutions to the constraints of non-negativity and unimodality (a requirement of a single maximum in an individual concentration profile). The cycle is repeated until convergence is achieved.

In various applications of the disclosed MAP and NDMC methods, the data was not pre-treated in any way. This serves for a better demonstration of the method's capacity for solving the analytical problem, starting with raw data and applying a minimum number of operations. Nevertheless, various pre-processing techniques, such as spectral smoothing or variable selection could be applied to partially remove noise and exclude non-informative measurements prior to the analysis. This would increase the method sensitivity and improve its accuracy at estimation of retention times. In practical data analysis, a situation may occur when the initial set of several analyses does not produce a satisfactory peak matching. The problem may often be resolved by adding new datasets to span more space of experimental parameters, thus making the augmented data matrix better conditioned. In various embodiments the methods can include steps to recognize and eliminate such non-analyte factors as drifting baseline, which may be a part of normal experimental data.

### EXAMPLES

The following examples are illustrative and not intended to be limiting. Two simulated series of chromatographic runs with diode array detector (DAD) analyses were used for demonstration of the method performance, one of them based on actual UV-Vis spectra. The choice of artificially constructed data was intentional.

Datasets:

Data matrices were constructed by the formula (Eq. 5):

Dⱼ=SQCⱼ+Dₑᵣᵣ (Eq 5)

Where Dⱼ is the (w×t) matrix of DAD data of jth run in a series of analyses of the same mixture, S the (w×n) matrix of component absorptivity spectra, Q the (n×n) diagonal matrix of component concentrations, Cⱼ the (n×t) matrix of component concentration profiles in ith experiment normalized to unit area, Dₑᵣᵣ the (w×t) matrix of experimental error (noise), w the number of wavelengths, t the number of spectra, and n the number of components.

Two series of analyses were emulated: Series A and Series B. Both of them included three simulated chromatographic runs of a ten-component mixture. The difference between the series can be attributed to the complexity of component peak patterns and the degree of their overlap. Series A represents a case of moderate complexity whereas Series B is constructed to model a challenging situation of badly resolved chromatograms. Moreover, the data in Series B were constructed with real UV-Vis spectra destined to emulate a chromatographic separation of substances of the same homological family: phenanthrene and its nine monosubstituted derivatives in positions 2, 3, and 9.

Each analysis in Series A consisted of 901 spectra (representing retention times from 0 to 900) registered at 351 wavelengths. Spectrochromatograms in Series B included 801 spectra at retention times from 0 to 800.

Typical noise added to the data matrices in Series A was a normally distributed error with the standard deviation (R.S.D.) equal to 0.001. Series B included two types of noise simultaneously present in the data. These were a constant (background) noise R.S.D.=0.0005 and a random error weighted by intensity (detector noise) R.S.D.=0.005. In some calculations noise was varied to check its influence on the solution.

Summary chromatograms in Series A and B (as maximum intensity plots), as well as constituting component concentration profiles, are presented in FIGS. 9A and 9B.

Series A Spectra

Each spectrum in Series A represented a sum of 1-3 wide Gaussian peaks with randomly chosen maxima (FIG. 9C) and covered the wavelength range from 200 to 900 nm with step 2 nm.

Series B Spectra

Spectra were obtained from the printed atlas by Lang (See Absorption Spectra in the Ultraviolet and Visible Region, vol. 1). Original spectra were acquired on a Beckman Model DU, in a cell with pathlength 1 cm. Spectra were registered by single absorbance measurements stepped between 1 and 5 nm. The substance concentration varied for different wavelength ranges to provide an accuracy of three significant digits. Ethanol was used as a solvent for substituted phenanthrenes. The spectrum of phenanthrene was registered in isooctane.

Spectra were digitized in the wavelength range from 210 to 360 nm with step 1 nm. Absorptivity spectra were calculated by division of measured values of spectral absorbance by substance concentration. Absorptivity spectra used for constructing Series B are shown in FIGS. 9D and 9E.

Component Concentrations

Component concentrations in Series A varied as shown in Table 1.

TABLE 1
Component concentrations (C₀, arbitrary units), retention times, maximum signal intensities
(absorbance), peak overlap (% area), and resolution
(in parentheses, lowest R₅ value for the peak) in Series A

| | | Retention times | | | Maximum intensity | | | Overlap (R₅) | | |
|---|---|---|---|---|---|---|---|---|---|---|
| # | C₀ | D₁ | D₂ | D₃ | D₁ | D₂ | D₃ | D₁ | D₂ | D₃ |
| 1 | 10 | 20 | 35 | 110 | 1.260 | 1.260 | 0.525 | 12 (0.50) | 42 (0.25) | 30 (0.18) |
| 2 | 50 | 30 | 100 | 100 | 4.519 | 3.163 | 6.326 | 2 (0.50) | 0 (2.07) | 6 (0.28) |
| 3 | 1 | 200 | 410 | 200 | 0.096 | 0.129 | 0.051 | 0 (2.08) | 0 (1.33) | 0 (2.57) |
| 4 | 5 | 250 | 40 | 25 | 0.927 | 1.043 | 1.669 | 0 (1.85) | 32 (0.25) | 0 (3.27) |
| 5 | 8 | 300 | 305 | 105 | 0.123 | 0.082 | 0.154 | 0 (1.85) | 0 (3.54) | 100 (0.18) |
| 6 | 2 | 400 | 610 | 500 | 0.049 | 0.049 | 0.033 | 0 (3.24) | 40 (0.43) | 0 (3.78) |
| 7 | 3 | 500 | 450 | 640 | 0.134 | 0.054 | 0.060 | 100 (0.30) | 0 (1.33) | 52 (0.29) |
| 8 | 40 | 510 | 550 | 300 | 0.730 | 0.913 | 1.095 | 10 (0.30) | 0 (1.67) | 0 (3.13) |
| 9 | 1 | 795 | 800 | 400 | 0.022 | 0.012 | 0.024 | 99 (0.21) | 0 (6.79) | 0 (4.00) |
| 10 | 4 | 800 | 600 | 650 | 0.454 | 0.568 | 0.454 | 5 (0.21) | 4 (0.43) | 12 (0.29) |

Initial component concentrations C₀ chosen to model the analyzed mixture in Series B are Table 2.

TABLE 2
Concentrations (C₀), component retention times. maximum signal intensities (absorbance), peak
overlap (% area), and resolution (in parentheses, lowest R₅ value
for the peak) in Series B

| | C₀ | Retention times | | | Maximum intensity | | | Overlap (R₅) | | |
|---|---|---|---|---|---|---|---|---|---|---|
| # | (10⁻⁶ × mol/l) | D₁ | D₂ | D₃ | D₁ | D₂ | D₃ | D₁ | D₂ | D₃ |
| 1 | 10 | 68 | 80 | 76 | 0.598 | 0.408 | 0.413 | 29 (0.17) | 50 (0.11) | 44 (0.13) |
| 2 | 7 | 75 | 75 | 81 | 0.166 | 0.226 | 0.312 | 69 (0.17) | 85 (0.11) | 98 (0.13) |
| 3 | 6 | 200 | 610 | 150 | 0.185 | 0.144 | 0.225 | 78 (0.08) | 3 (0.29) | 17 (0.47) |
| 4 | 5 | 203 | 200 | 292 | 0.175 | 0.129 | 0.242 | 100 (0.08) | 0 (2.73) | 43 (0.23) |
| 5 | 12 | 210 | 400 | 400 | 0.301 | 0.220 | 0.320 | 53 (0.18) | 47 (0.20) | 0 (2.63) |
| 6 | 70 | 300 | 408 | 166 | 0.232 | 0.390 | 0.243 | 62 (0.00) | 65 (0.20) | 11 (0.47) |
| 7 | 50 | 300 | 700 | 750 | 0.135 | 0.236 | 0.164 | 100 (0.00) | 0 (2.25) | 3 (0.17) |
| 8 | 40 | 400 | 420 | 500 | 0.125 | 0.095 | 0.090 | 0 (2.70) | 99 (0.08) | 0 (2.63) |
| 9 | 60 | 500 | 423 | 300 | 0.149 | 0.154 | 0.142 | 0 (2.70) | 73 (0.08) | 46 (0.23) |
| 10 | 2 | 700 | 600 | 755 | 0.007 | 0.003 | 0.004 | 0 (6.45) | 96 (0.29) | 100 (0.17) |

Although the mixture was intended to have the same composition throughout the analysis, some error was added to bring more realism to the data. The actual concentration involved in the data construction contained normally distributed error with 10% standard deviation of the initial concentration value C₀. The error was randomly generated and added individually in every experiment. Thus, all of the modeled analyses were somewhat different in component ratio.

Concentration Profiles

Concentration profiles were modeled by the Gaussian function with unit height and half-height width chosen as a random integer number between 5 and 20. All profiles were then normalized to unit area to provide equal areas of the same profile in different analyses provided that the concentration is constant. Peak positions were set to provide the desired complexity of the pattern in each series.

Peak positions were chosen to provide almost every component peak being overlapped to a different extent up to 100% (embedded peak) by another signal in at least one of the analyses (Table 1). The resulting concentration profiles are shown in FIG. 9B.

The peak pattern was created to provide the following conditions of complexity (Table 2):

Every component is overlapped at least once through the series;

Five components of ten have overlapped signals in every experiment;

There are partially overlapping groups of two, three, and four peaks;

Embedded peaks are present; and

There is an instance of two peaks with coinciding retention times.

The resulting concentration profiles are shown in FIG. 9C.

Principal component analysis of the augmented data matrix D_{aug} followed by comparison of the R.S.D. for different values of n with the experimental error known to be 0.001 detected nine primary factors (principal components). Ninth factor is disputable, its R.S.D. is almost equal to the error. The factor was kept based on the IND function method results (Table 3). The fact that one of the mixture components was assigned secondary factors can account for the low intensity of the component signals significantly affected by the noise. Nevertheless, the dimensionality of the factor space was increased by two as recommended (n=11).

TABLE 3
PCA of D_{aug} in Series A: residual standard deviation
(R.S.D.) and decimal logarithm of indicator function
(IND) for different number of factors (NF)

| NF | R.S.D. (×10³) | Ig(IND) |
|---|---|---|
| 1 | 69.517 | −6.246 |
| 2 | 34.392 | −6.549 |
| 3 | 13.036 | −6.968 |
| 4 | 7.363 | −7.214 |
| 5 | 1.834 | −7.815 |
| 6 | 1.185 | −8.002 |
| 7 | 1.067 | −8.045 |
| 8 | 1.008 | −8.067 |
| 9 | 0.999 | −8.068 |
| 10 | 0.996 | −8.067 |
| 11 | 0.995 | −8.065 |
| 12 | 0.994 | −8.063 |

IKSFA on the columns of the D_{aug} resulted in a key set of 11 spectra collected among all the experiments. Their retention times were (the experiment number is given in parentheses): 100 (3); 300 (3); 25 (3); 20 (1); 600 (2); 410 (2); 105 (3); 500 (1); 400 (1); 400 (3); 49* (1). Note that every key set spectrum except one (denoted by *) matches the retention time of an actual component (Table 1).

Visual inspection of spectra of the key set provides a rationale for rejection of spectrum 11 as containing nothing but noise (FIG. 9F). Spectrum 10, while also noisy, still brings some real information; the operator may decide to retain it. Target testing of the key set in the abstract space of augmented data leads to the same conclusion. SPOIL=48 for spectrum 11 is a non-ambiguous proof of its uniqueness. At the same time, spectrum 10 produces the SPOIL=5.0 leaving the decision whether to retain the component up to an operator, although the key set refinement has rejected the tenth factor as non-optimal according to condition (4).

Concentration profiles were calculated and peak tables obtained for both nine- and ten-component models (Table 4). Comparing the results with the original data (Table 1) shows that the calculation accuracy (measured as the root mean square error, rms) of retention times is better in the model with nine components. The tenth component (its assigned number is 9) is a signal of very low intensity and introduces the noise it is mixed with into the whole model, disturbing other factors. Thus, there is a trade-off between accuracy and the potential for loss of components. Regardless, reasonable results can still be obtained.

TABLE 4
Calculated retention times in nine-
and ten-component models (Series A)

| | Ten components^{a} | | | Nine components^{b} | | |
|---|---|---|---|---|---|---|
| # | D₁ | D₂ | D₃ | D₁ | D₂ | D₃ |
| 1 | 20 | 35 | 110 | 20 | 35 | 112 |
| 2 | 30 | 100 | 100 | 30 | 100 | 100 |
| 3 | 200 | 410 | 200 | 200 | 410 | 201 |
| 4 | 250 | 40 | 25 | 250 | 40 | 25 |
| 5 | 300 | 305 | 105 | 300 | 305 | 105 |
| 6 | 400 | 611 | 502 | 400 | 611 | 500 |
| 7 | 500 | 450 | 638 | 500 | 450 | 640 |
| 8 | 510 | 550 | 300 | 510 | 550 | 300 |
| 9 | 795 | 800 | 401 | — | — | — |
| 10 | 800 | 600 | 649 | 800 | 600 | 650 |

^{a}rms = 0.6325.
^{b}rms = 0.4714.

The influence of noise level on the method detection and peak matching capabilities was investigated. The added error in the data for the above calculation was R.S.D.=0.001. When the noise was decreased to R.S.D.=0.0009 or less, all ten components passed the refinement procedure followed by successful peak matching. Increasing the noise level to the standard deviation value of 0.001 9 led to a refined key set of eight IKSFA-produced spectra. Nevertheless, peak matching is still able to satisfactorily recognize peaks from nine components (1-8, 10) up to approximately R.S.D.=0.004. However, the error in detecting peak positions at that level of noise reaches rms=1.089. Under these conditions, the refinement procedure detects an optimal key set of six component spectra (1-4, 8, 10), and their retention times calculated for a six-factor model exactly fit the true values. At the same time, the error of localization of the same six components at n=9 amounts to rms=0.557. This result is a vivid demonstration of the fact that retention in the key set of the non-optimal spectra rejected at the refinement stage introduces a large amount of error in the result. This may still produce a sensible solution, but the error significantly affects the high-intensity components that are matched accurately with an optimal key set. If the noise is increased above 0.004, a solution can only be found for eight components. Retention times of components 6 and 9, having the smallest intensity in the series, are detected incorrectly. An incorrect result, as a rule, means that a minor component peak is not detected in one or more chromatographic runs of the series. A retention time that belongs to another, already matched peak (a duplicate) often appears instead. In practice, mismatch detection may be problematic; therefore, one should carefully inspect a solution obtained with a key set that does not meet the optimum condition (4).

Comparing the above results with maximum intensities of analytes (Table 1), one can estimate the general sensitivity of the present peak matching method in the presence of normally distributed background noise. The method is capable of detecting signals 8-10 times the noise standard deviation (in fact, this is SNR, signal-to-noise ratio) as it was shown for the lowest intensity mixture components 9 and 6. Reliable detection and matching is achieved for those component peaks whose SNR is above 15-20 times experimental error. Peaks below this level are detected at the expense of accuracy of the entire solution. High error in the data does not generally lead to method failure but only to loss of some minor components which, being spoiled by the noise, are detected at the refinement stage.

In order to check how missing components can be detected among the calculated retention times, the signal of component 3 was removed from the data matrix of experiment 1 and recalculated the table of peaks for 10 components. Every spectrum of the common key set was then target tested for presence in the abstract space of each individual experiment. Obtained RET values are given in Table 5. A visual demonstration of successful and failed target tests is given in FIGS. 9G and 9H.

TABLE 5
Results of target testing (RET) of key set spectra
on individual experiments in Series A

| # | D₁ | D₂ | D₃ |
|---|---|---|---|
| 1 | 0.001 | 0.001 | 0.001 |
| 2 | 0.001 | 0.001 | 0.001 |
| 3 | 0.018 | 0.001 | 0.001 |
| 4 | 0.001 | 0.001 | 0.001 |
| 5 | 0.001 | 0.001 | 0.001 |
| 6 | 0.001 | 0.001 | 0.001 |
| 7 | 0.001 | 0.001 | 0.001 |
| 8 | 0.001 | 0.001 | 0.001 |
| 9 | 0.001 | 0.001 | 0.001 |
| 10 | 0.001 | 0.001 | 0.001 |

Data matrices were successfully decomposed into normalized concentration profiles and corresponding spectra for all ten components. The correlation coefficients between original and reconstructed spectra were 0.9982 and higher.

Test Case of High Complexity (Series B)

PCA on the augmented data matrix detected nine primary factors. This number was increased by 2 and 11 key spectra were calculated by the IKSFA method. However, after the key refinement procedure, only nine spectra remained (FIG. 9I) at the following retention times (the experiment number is given in parentheses): 408 (2); 68 (1); 82 (3); 400 (1); 400 (3); 292 (3); 150 (3); 423 (2); 700 (2).

The extracted key spectra were processed by the peak matching procedure to produce the component retention times shown in Table 6.

TABLE 6
Calculated retention times in nine-component
model resulting from peak matching and improved
by ALS MCR curve resolution (Series B)

| | Peak matching^{a} | | | ALS MCR^{b} | | |
|---|---|---|---|---|---|---|
| # | D₁ | D₂ | D₃ | D₁ | D₂ | D₃ |
| 1 | 68 | 83 | 73 | 68 | 81 | 75 |
| 2 | 78 | 74 | 82 | 76 | 74 | 81 |
| 3 | 199 | 611 | 150 | 199 | 611 | 150 |
| 4 | 203 | 200 | 292 | 203 | 200 | 292 |
| 5 | 210 | 398 | 400 | 210 | 400 | 400 |
| 6 | 300 | 408 | 166 | 300 | 408 | 166 |
| 7 | 299 | 700 | 750 | 299 | 700 | 750 |
| 8 | 400 | 416 | 500 | 400 | 420 | 500 |
| 9 | 500 | 423 | 301 | 500 | 423 | 300 |
| 10 | — | — | — | — | — | — |

^{a}rms = 1.401.
^{b}rms = 0.5092.

One can see that the minor intensity component 10 in the mixture has not been matched. However, this is an expected result considering the noise level (SNR˜6) and its high degree of overlap in experiments 2 and 3. The results obtained are more than satisfactory. The maximum error in detection of component retention times worked out to be only four units, which is an acceptable error for the purpose of further optimization of the chromatographic separation, assuming that this is the goal of the peak matching. Note that for NDMC purposes, detection, rather than retention time extraction, is the final objective. The method detected overlapping peaks, even when there was a great deal of mathematical ambiguity as embedded and co-eluting signals. The model with nine components accounted for 99.99% of the cumulative variance in the data.

ALS MCR curve resolution, started from initial estimates of peak retention times, successfully converged in the nine-component model (FIG. 9J). The Correlation Coefficients between the original and reconstructed spectra were 0.9980 and higher. The improved concentration profiles resulted in noticeable improvement in the predicted retention times (Table 6).

However, ALS MCR failed to resolve the curves in the ten-component model. This should not be a surprise, considering strict assumptions about peak and spectrum shapes. Distortions caused by the noise in the minor component signals may be crucial for the method convergence.

While the present invention has been described in terms of certain exemplary preferred embodiments, it will be readily understood and appreciated by one of ordinary skill in the art that it is not so limited and that many additions, deletions and modifications to the preferred embodiments may be made within the scope of the invention as hereinafter claimed. Accordingly, the scope of the invention is limited only by the scope of the appended claims.

What is claimed is:

1. A method of characterizing a mixture of components, the method comprising the steps of:
obtaining a plurality of spectrochromatograms of the mixture of components, each of the spectrochromatograms being obtained under a respective one of a plurality of different chromatographic conditions;
estimating the number of components and
performing component matching upon the spectrochromatograms using the estimated number of components.

2. The method of claim 1 further comprising the step of determining each component retention time in response to the component matching.

3. The method of claim 1 further comprising the step of determining each component spectral shape in response to the component matching.

4. The method of claim 3 further comprising the step of using the component spectral shape to identify the component.

5. The method of claim 1 further comprising the step of resolving at least one component in the mixture of components.

6. A method of component peak matching comprising the steps of:
obtaining a plurality of spectrochromatographic data sets for a mixture of components, each spectrochromatographic data set comprising spectrochromatographic data;
creating an augmented spectrochromatographic data set by merging the spectrochromatographic data sets into a matrix;
determining a preliminary estimate of the number of components (n) in the augmented spectrochromatographic data set;
selecting the (n) most orthogonal spectrochromatographic data from the augmented spectrochromatographic data set;
generating a refined key spectra set; and
determining the component retention times.

7. The method of claim 6 further comprising the step of:
validating each of the (n) most orthogonal spectrochromatographic data using target factor analysis to generate the refined key spectra set.

8. The method of claim 6 further comprising the step of detecting missing components using target testing of each spectrochromatographic data in the refined key spectra set against each of the plurality of spectrochromatographic data sets.

9. The method of claim 6 wherein the step of determining a preliminary estimate uses principle component analysis.

10. The method of claim 6 wherein the step of determining a preliminary estimate uses single value decomposition.

11. The method of claim 6 wherein the step of determining a preliminary estimate uses nonlinear iterative partial least squares.

12. The method of claim 6 wherein the step of selecting the (n) most orthogonal spectra uses modified Iterative Key Set Factor Analysis.

13. The method of claim 6 wherein the step of determining the component retention times comprises:
performing a regression using the refined key spectra set and the augmented data matrix; and
determining retention times as maximum values.

14. A method for resolving a mixed sample of chromatographic components, the method comprising the steps of:
selecting a plurality of differing chromatographic conditions;
performing a plurality of chromatographic runs on the mixed sample, each respective run performed under a respective chromatographic condition;
obtaining spectrochromatographic data for the mixed sample during each of the chromatographic runs;
creating an augmented data set from the spectrochromatographic data of the plurality of chromatographic runs;
operating on the augmented data set to determine the retention times for each component in the mixed sample; and
resolving each of the components.

15. The method of claim 14 further comprising the step of performing component quantitation.

16. The method of claim 15 wherein the step of performing component quantitation uses resolved spectra and concentration profiles.

17. The method of claim 14 further comprising the step of finding peak relative areas using concentration profiles.

18. A method of obtaining the shape of components from spectrochromatographic data comprising the steps of:
determining the number of components (n) and each component's retention time;
generating uniqueness vectors as initial estimates of spectrochromatographic profiles; and
performing profile resolution on the spectrochromatographic data.

19. The method of claim 18 wherein the step of performing profile resolution uses ALS MCR.
